(19) United States
(12) Patent Application Publication
(10) Pub. No.: US 2025/0035753 A1
(43) Pub. Date: Jan. 30, 2025

(54) SINGLE PHOTON DETECTION DEVICE AND ELECTRONIC DEVICE COMPRISING SILICIDE

(71) Applicant: Trupixel Inc., Daejeon (KR)

(72) Inventor: Myung-Jae LEE, Seoul (KR)

(21) Appl. No.: 18/784,684

(22) Filed: Jul. 25, 2024

(30) Foreign Application Priority Data
Jul. 25, 2023 (KR) 10-2023-0096675
Jul. 25, 2024 (KR) 10-2024-0098239

(51) Int. Cl. G01S 7/481; G01S 17/10

(52) U.S. Cl. CPC G01S 7/4816; G01S 17/10

(57) ABSTRACT

A single photon detection device comprises a first silicide layer, a first well provided on the first silicide layer and having a first conductivity type, a high-concentration doping region provided between the first silicide layer and the first well, having a second conductivity type different from the first conductivity type, and contacting the first silicide layer, a contact region spaced apart from the high-concentration doping region along a direction parallel to a bottom surface of the high-concentration doping region and having the first conductivity type, and a depletion region formed in a region adjacent to a top surface of the high-concentration doping region.

### CROSS-REFERENCE TO RELATED APPLICATIONS

The application claims benefit of priority under 35 U.S.C. § 119 to Korean Patent Application Nos. 10-2023-0096675 filed on Jul. 25, 2023, and 10-2024-0098239 filed on Jul. 25, 2024, in the Korean Intellectual Property Office, the disclosures of which are incorporated by reference herein in their entireties.

### BACKGROUND

The present disclosure relates generally to photodetection elements, photodetectors, and electronic devices.

An avalanche photodiode (APD) is a solid-state photodetector where a high bias voltage is applied to a p-n junction to provide high gain due to avalanche multiplication. When an incident photon with energy greater than the semiconductor's bandgap reaches the photodiode, an electron-hole pair (EHP) is generated. The high electric field rapidly accelerates the photo-generated electron towards the (+) side, and impact ionization by these accelerated electrons successively generates additional electron-hole pairs, which are then all accelerated towards the anode. Similarly, holes are rapidly accelerated towards the (−) side and cause the same phenomenon. This process repeats, leading to avalanche multiplication of the photo-generated electron or hole. Thus, the APD is a semiconductor-based device that operates similarly to photomultiplier tubes. Linear-mode APDs are effective amplifiers that can set the gain by controlling the bias voltage and achieve gains of tens to thousands in linear mode.

A single-photon avalanche diode (SPAD) is an APD where the p-n junction is biased above its breakdown voltage to operate in Geiger mode. A single incident photon can trigger an avalanche phenomenon, generating a very large current, which can easily produce a measurable pulse when combined with a quenching resistor or circuit. In other words, the SPAD operates as a device that generates large pulses compared to linear-mode APDs. After triggering an avalanche, a quenching resistor or circuit is used to reduce the bias voltage below the breakdown voltage to quench the avalanche process. Once quenched, the bias voltage is raised again above the breakdown voltage to reset the SPAD for detecting another photon.

The SPADs can be configured with quenching resistors or circuits, as well as recharge circuits, memory, gate circuits, counters, time-to-digital converters, and more. Because SPAD pixels are semiconductor-based, they can be easily arranged into arrays.

### SUMMARY

Embodiments of the present disclosure provide miniaturized photodetection devices, photodetectors, and electronic devices with improved light detection efficiency, wide light detection wavelength range, improved fill factor, and enhanced efficiency.

According to example embodiments, a single photon detection device comprises a first silicide layer, a first well provided on the first silicide layer and having a first conductivity type, a high-concentration doping region provided between the first silicide layer and the first well, having a second conductivity type different from the first conductivity type, and contacting the first silicide layer, a contact region spaced apart from the high-concentration doping region along a direction parallel to a bottom surface of the high-concentration doping region and having the first conductivity type, and a depletion region formed in a region adjacent to a top surface of the high-concentration doping region.

According to further aspects of the invention, a second silicide layer covering a bottom surface of the contact region.

According to further aspects of the invention, the first well extends to a region between the high-concentration doping region and the contact region, and the first well is exposed between the first silicide layer and the second silicide layer.

According to further aspects of the invention, a relaxation region covering one side surface and a top surface of the contact region, having the first conductivity type, and having a lower doping concentration than that of the contact region.

According to further aspects of the invention, a first vertical connection provided on an opposite side of the contact region with respect to the second silicide layer, the second silicide layer electrically connects the contact region and the first vertical connection.

According to further aspects of the invention, the second silicide layer has a ring shape surrounding the first silicide layer.

According to further aspects of the invention, a guard ring provided between the high-concentration doping region and the contact region, the first silicide layer extends to a bottom surface of the guard ring.

According to further aspects of the invention, an insulation pattern inserted to a lower region of the guard ring.

According to further aspects of the invention, a low-concentration doping region covering a side surface and the top surface of the high-concentration doping region, the first silicide layer covers a bottom surface of the low-concentration doping region.

According to further aspects of the invention, an additional guard ring provided on a top surface of the guard ring, having the same conductivity type as the guard ring, and having a doping concentration different from the guard ring.

According to further aspects of the invention, a second vertical connection provided on an opposite side of the high-concentration doping region with respect to the first silicide layer, the first silicide layer electrically connects the high-concentration doping region and the second vertical connection.

According to further aspects of the invention, a second silicide layer covering a bottom surface of the contact region, a first vertical connection provided on an opposite side of the contact region with respect to the second silicide layer, an output pattern electrically connected to an end of the second vertical connection, and a bias pattern electrically connected to an end of the first vertical connection and spaced apart from the output pattern.

According to further aspects of the invention, a shield pattern located between the output pattern and the bias pattern, and spaced apart from the output pattern and the bias pattern.

According to further aspects of the invention, circuits of a control layer electrically connected to the output pattern and the bias pattern, the control layer is provided in the form of a separate chip.

According to further aspects of the invention, a second well provided between the high-concentration doping region and the first well and having the first conductivity type.

According to further aspects of the invention, a third well provided between the high-concentration doping region and the first well, having the second conductivity type, and having a lower doping concentration than that of the high-concentration doping region.

According to further aspects of the invention, a height of a Schottky barrier between the first silicide layer and the high-concentration doping region is smaller than a bandgap energy of the first well.

According to example embodiments, an electronic device configured to measure the distance to a subject using time difference information between a transmission signal of a light emission device and a detection signal of a single photon detection device, the electronic device comprising the light emission device and the single photon detection device for detecting incident light reflected from the subject after being emitted from the light emission device. The single photon detection device comprises a first silicide layer, a first well provided on the first silicide layer and having a first conductivity type, a high-concentration doping region provided between the first silicide layer and the first well, having a second conductivity type different from the first conductivity type, and contacting the first silicide layer, a contact region spaced apart from the high-concentration doping region along a direction parallel to a bottom surface of the high-concentration doping region and having the first conductivity type, and a depletion region formed in a region adjacent to a top surface of the high-concentration doping region.

According to further aspects of the invention, a second silicide layer covering a bottom surface of the contact region.

According to further aspects of the invention, a guard ring provided between the high-concentration doping region and the contact region, the first silicide layer extends to a bottom surface of the guard ring.

Additional aspects will be set forth in part in the description which follows and, in part, will be apparent from the description, or may be learned by practice of some example embodiments of the inventive concepts.

### BRIEF DESCRIPTION OF DRAWINGS

The above and other aspects, features, and advantages of some example embodiments of the present disclosure will be more apparent from the following description taken in conjunction with the accompanying drawings, in which:

FIG. 1 is a plan view of a single photon detection device according to some example embodiments.

FIG. 2 is a plan view for explaining a first silicide layer and a second silicide layer.

FIG. 3 is a cross-sectional view along the A-A′ line of FIG. 1.

FIG. 4 is a plan view for explaining an output pattern, a bias pattern, and a shield pattern.

FIG. 5A is a plan view of the single photon detection device of FIG. 2 according to some example embodiments.

FIG. 5B is a plan view for explaining the first silicide layer and the second silicide layer.

FIGS. 6A, 7A, 8A, 9A, and 10A are plan views of the single photon detection device of FIG. 2 according to some example embodiments.

FIGS. 6B, 7B, 8B, 9B, and 10B are plan views for explaining the first silicide layer and the second silicide layer.

FIGS. 11 and 12 are cross-sectional views corresponding to the A-A′ line of FIG. 1.

FIG. 13A is a plan view of a single photon detection device according to some example embodiments.

FIG. 13B is a plan view for explaining the first silicide layer and the second silicide layer.

FIG. 14 is a cross-sectional view along the B-B′ line of FIG. 13A.

FIG. 15A is a plan view of a single photon detection device according to some example embodiments.

FIG. 15B is a plan view for explaining the first silicide layer and the second silicide layer.

FIG. 16 is a cross-sectional view along the C-C′ line of FIG. 15A.

FIG. 17A is a plan view of a single photon detection device according to some example embodiments.

FIG. 17B is a plan view for explaining the first silicide layer and the second silicide layer.

FIG. 18 is a cross-sectional view along the D-D′ line of FIG. 17A.

FIG. 19A is a plan view of a single photon detection device according to some example embodiments.

FIG. 19B is a plan view for explaining the first silicide layer and the second silicide layer.

FIG. 20 is a cross-sectional view along the E-E′ line of FIG. 19A.

FIG. 21A is a plan view of a single photon detection device according to some example embodiments.

FIG. 21B is a plan view for explaining the first silicide layer and the second silicide layer.

FIG. 22 is a cross-sectional view along the F-F′ line of FIG. 21A.

FIG. 23 is a plan view of a single photon detection device according to some example embodiments.

FIG. 24 is a cross-sectional view along the G-G′ line of FIG. 23.

FIGS. 25, 26, 27, 28, 29, and 30 are cross-sectional views corresponding to the A-A′ line of FIG. 1.

FIG. 31A is a plan view of a single photon detection device according to some example embodiments.

FIG. 31B is a plan view for explaining the first silicide layer and the second silicide layer.

FIG. 32 is a cross-sectional view along the H-H′ line of FIG. 31A.

FIGS. 33 and 34 are cross-sectional views corresponding to the A-A′ line of FIG. 1.

FIG. 35A is a plan view of a single photon detection device according to some example embodiments.

FIG. 35B is a plan view for explaining the first silicide layer and the second silicide layer.

FIG. 36 is a cross-sectional view along the J-J′ line of FIG. 35A.

FIG. 37 is a cross-sectional view corresponding to the A-A′ line of FIG. 1.

FIGS. 38A and 38B are plan views of the optical pattern layer according to some example embodiments of FIG. 37.

FIGS. 39, 40, and 41 are cross-sectional views corresponding to the A-A′ line of FIG. 1.

FIG. 42 is a plan view of a single photon detection device array according to some example embodiments.

FIG. 43 is a cross-sectional view along the K-K′ line of FIG. 42.

FIG. 44 is a plan view of the output pattern, bias pattern, and shield pattern of FIG. 43.

FIGS. 45, 46, 47, 48, 49, 50, 51, and 52 are cross-sectional views along the K-K′ line of FIG. 42.

FIG. 53 is a block diagram for explaining an electronic device according to some example embodiments.

FIGS. 54 and 55 are conceptual diagrams illustrating the application of a LiDAR device to a vehicle according to some example embodiments.

### DETAILED DESCRIPTION

Hereinafter, some example embodiments are described in detail with reference to the accompanying drawings. Like components are denoted by like reference numerals throughout the specification, and repeated descriptions thereof are omitted. It will be understood that when an element or layer is referred to as being “on,” “connected to” or “coupled to” another element or layer, it can be directly on, connected or coupled to the other element or layer, or intervening elements or layers may be present. By contrast, when an element is referred to as being “directly on,” “directly connected to” or “directly coupled to” another element or layer, there are no intervening elements or layers present. Embodiments described herein are some example embodiments, and thus, the present disclosure is not limited thereto, and may be realized in various other forms. Some example embodiments provided in the following description is not excluded from being associated with one or more features of some other example embodiments also provided herein or not provided herein but consistent with the present disclosure. It will be also understood that, even if a certain step or operation of manufacturing an apparatus or structure is described later than another step or operation, the step or operation may be performed later than the other step or operation unless the other step or operation is described as being performed after the step or operation.

When the terms “about” or “substantially” are used in this specification in connection with a numerical value, it is intended that the associated numerical value includes a manufacturing or operational tolerance (e.g., ±10%) around the stated numerical value. Moreover, when the words “generally” and “substantially” are used in connection with geometric shapes, it is intended that precision of the geometric shape is not required but that latitude for the shape is within the scope of the disclosure. Further, regardless of whether numerical values or shapes are modified as “about” or “substantially,” it will be understood that these values and shapes should be construed as including a manufacturing or operational tolerance (e.g., ±10%) around the stated numerical values or shapes. When ranges are specified, the range includes all values therebetween such as increments of 0.1%.

Also, for example, “at least one of A, B, and C” and similar language (e.g., “at least one selected from the group consisting of A, B, and C”) may be construed as A only, B only, C only, or any combination of two or more of A, B, and C, such as, for instance, ABC, AB, BC, and AC.

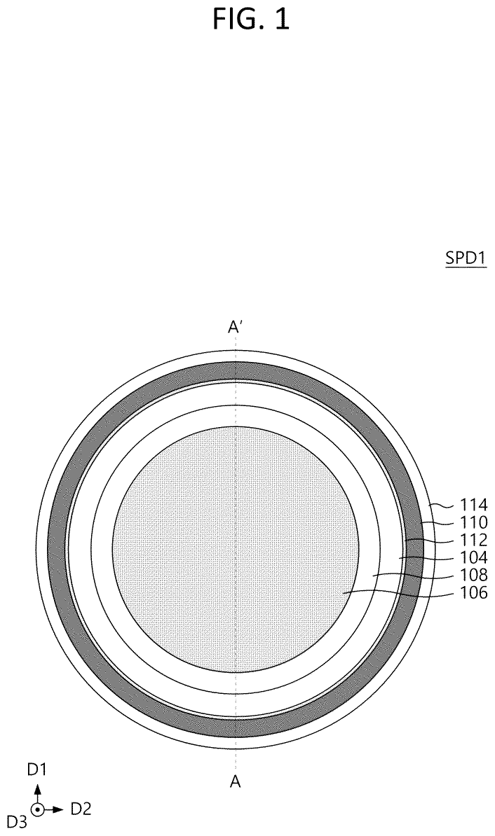

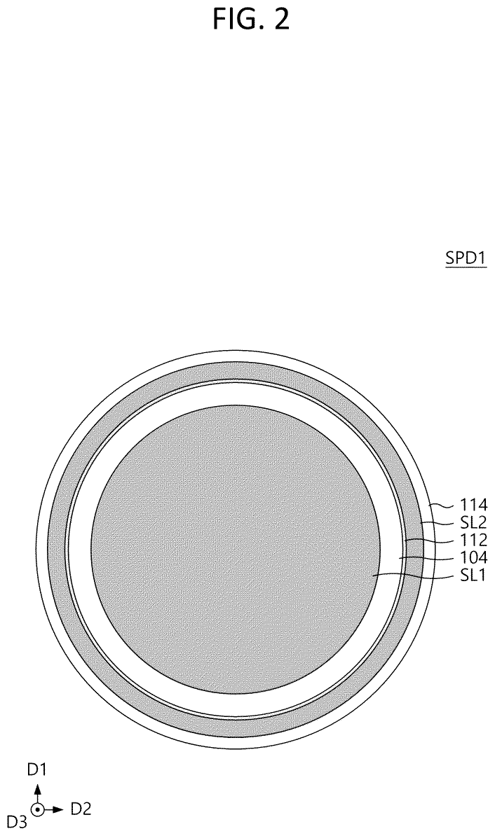

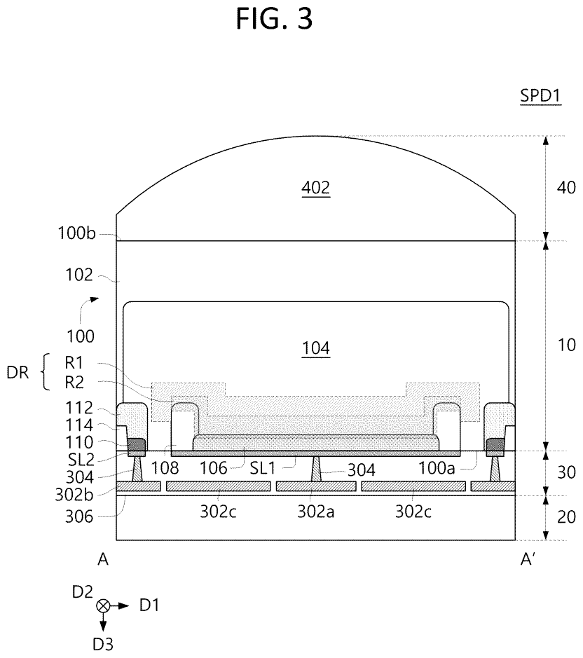

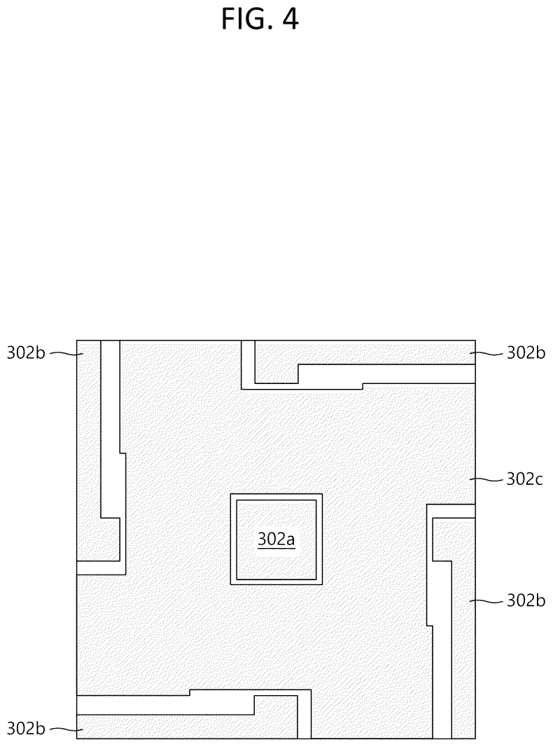

FIG. 1. is a plan view of a single photon detection device according to some example embodiments. FIG. 2 is a plan view for explaining a first silicide layer and a second silicide layer. FIGS. 3A and 3B are cross-sectional views of some example embodiments along the A-A′ line of FIG. 1. FIG. 4 is a plan view for explaining an output pattern, a bias pattern, and a shield pattern.

Referring to FIGS. 1 to 4, a single photon detection device SPD1 may be provided. The single photon detection device SPD1 may include a light detection layer 10, a control layer 20, a connection layer 30, and an optical element layer 40. The light detection layer 10 may be provided between the connection layer 30 and the optical element layer 40. The control layer 20 may be provided on the opposite side of the light detection layer 10 with respect to the connection layer 30. The single photon detection device SPD1 may be a backside illumination (BSI) type image sensor. The backside illumination method may refer to light entering through the backside surface 100b of the substrate 100. The front-side illumination method, which will be described later, may refer to light entering through the frontside surface 100a of the substrate 100.

The light detection layer 10 may be provided. The light detection layer 10 may include a first well 104, a high-concentration doping region 106, a guard ring 108, a contact region 110, a relaxation region 112, and a device isolation pattern 114 formed in a semiconductor substrate 100. In some example embodiments, the high-concentration doping region 106 may have a circular shape, and the guard ring 108, first well 104, relaxation region 112, contact region 110, and device isolation pattern 114 may have circular ring shapes surrounding the high-concentration doping region 106. The semiconductor substrate 100 may be an epitaxial layer formed by an epitaxial growth process. For example, the semiconductor substrate 100 may be a silicon substrate. The semiconductor substrate 100 may include a frontside surface 100a and a backside surface 100b facing each other. The frontside surface 100a may be the surface where various semiconductor processes are performed during the manufacture of the light detection layer 10, and the backside surface 100b may be the surface opposite to the frontside surface. The frontside surface 100a and backside surface 100b may extend along a first direction D1 and a second direction D2. The direction from the backside surface 100b towards the frontside surface 100a may be a third direction D3. For example, the first well 104, high-concentration doping region 106, guard ring 108, contact region 110, and relaxation region 112 may be formed by impurities being implanted into the semiconductor substrate 100. The remaining region of the semiconductor substrate 100 excluding the first well 104, high-concentration doping region 106, guard ring 108, contact region 110, and relaxation region 112 may be referred to as the substrate region 102.

The conductivity type of the substrate region 102 may be n-type or p-type. When the conductivity type of the substrate region 102 is n-type, it may include impurities such as group 5 elements (e.g., phosphorus (P), arsenic (As), antimony (Sb), etc.), group 6, or group 7 elements. Hereinafter, regions with n-type conduction may include group 5, 6, or 7 elements as impurities (hereinafter, first impurities). When the conductivity type of the substrate region 102 is p-type, the substrate region 102 may include impurities such as group 3 elements (e.g., boron (B), aluminum (Al), gallium (Ga), indium (In), etc.) or group 2 elements. Hereinafter, regions with p-type conduction may include group 3 or 2 elements as impurities (hereinafter, second impurities). For example, the doping concentration of the substrate region 102 may be 1×10¹⁴ to 1×10¹⁹ cm⁻³. The semiconductor substrate may be an epitaxial layer formed by an epitaxial growth process.

The first well 104 may be provided between the substrate region 102 and the connection layer 30. The first well 104 may directly contact the substrate region 102. The first well 104 may have a first conductivity type. For example, the doping concentration of the first well 104 may be 1×10¹⁵ to 1×10¹⁸ cm⁻³. In some example embodiments, the first well 104 may have a uniform doping concentration. In some example embodiments, the doping concentration of the first well 104 may decrease as it gets closer to the frontside surface 100a. Although it is illustrated that the bottom surface of the first well 104 is arranged up to the frontside surface 100a, this is not limiting. In some example embodiments, the bottom surface of the first well 104 may be arranged above the frontside surface 100a.

The high-concentration doping region 106 may be provided between the first well 104 and the connection layer 30. The high-concentration doping region 106 may contact the bottom surface of the first well 104. The high-concentration doping region 106 may be provided between the guard rings 108 described later. The high-concentration doping region 106 may have a second conductivity type different from the first conductivity type. As the high-concentration doping region 106 and the first well 104 have different conductivity types, a depletion region DR may be formed at and around the interface between the high-concentration doping region 106 and the first well 104. When the first conductivity type is n-type or p-type, the second conductivity type may be p-type or n-type, respectively. For example, the doping concentration of the high-concentration doping region 106 may be 1×10¹⁵ to 2×10²¹ cm⁻³. The high-concentration doping region 106 may be electrically connected to at least one of an external power source, a DC-DC converter, and other power management integrated circuits. In some example embodiments, the high-concentration doping region 106 may be electrically connected to at least one of a quenching resistor (or quenching circuit) and other pixel circuits. The quenching resistor or quenching circuit may stop the avalanche effect and allow the light detection layer 10 to detect another photon. Other pixel circuits may include, for example, reset or recharge circuits, memory, amplification circuits, counters, gate circuits, time-to-digital converters, etc. Also, the pixel circuit may transmit signals to the light detection layer 10 or receive signals from the light detection layer 10.

The guard ring 108 may surround the high-concentration doping region 106. The guard ring 108 may be provided on the side of the high-concentration doping region 106. For example, the guard ring 108 may have a ring shape extending along the side of the high-concentration doping region 106. The guard ring 108 may directly contact the high-concentration doping region 106. The guard ring 108 may be configured to surround the end of the high-concentration doping region 106. For example, the guard ring 108 may contact the side and top surface of the end of the high-concentration doping region 106. In some example embodiments, the guard ring 108 may be spaced apart from the high-concentration doping region 106. The bottom surface of the guard ring 108 may be arranged at substantially the same level as the bottom surface of the high-concentration doping region 106. The guard ring 108 may have the second conductivity type. The doping concentration of the guard ring 108 may be determined so that the second region R2 is formed along the top surface and inner side surface of the guard ring 108 and the top surface of the high-concentration doping region 106. For example, the doping concentration of the guard ring 108 may be determined so that an electric field with a magnitude of 3×10⁵ V/cm or more is applied to the second region R2 during the operation of the single photon detection device SPD1. In some example embodiments, the doping concentration of the guard ring 108 may be substantially the same as or lower than the doping concentration of the high-concentration doping region 106. For example, the doping concentration of the guard ring 108 may be 1×10¹⁵ to 5×10¹⁷ cm⁻³. In some other example embodiments, the doping concentration of the guard ring 108 may be determined so that the second region R2 is formed along the inner side surface of the guard ring 108 and the top surface of the high-concentration doping region 106, excluding the top surface of the guard ring 108. The guard ring 108 may improve the breakdown characteristics of the light detection layer 10. Specifically, the guard ring 108 may mitigate the concentration of electric field in a portion of the depletion region DR, thereby preventing premature breakdown. Premature breakdown is a phenomenon where breakdown occurs in a portion of the depletion region DR before a sufficient magnitude of electric field is applied across the entire depletion region DR, which occurs due to the concentration of electric field in a portion of the depletion region DR. The depth of the guard ring 108 may be determined as needed. For example, the guard ring 108 may be formed deeper or shallower than illustrated.

The depletion region DR may include a first region R1 and a second region R2. The first region R1 may be configured to transfer carriers (e.g., holes or electrons) generated in the light detection layer 10 by light incident on the light detection layer 10 to the second region R2. During the operation of the single photon detection device SPD1, an electric field with a magnitude smaller than 3×10⁵ V/cm may be applied to the first region R1. For example, carriers may move to the second region R2 by the electric field applied to the first region R1. Carriers generated in the non-depletion region (hereinafter, non-depletion region) excluding the depletion region DR may move in random directions. Among the carriers generated in the non-depletion region, those that reach the first region R1 may move to the second region R2 by the electric field applied to the first region R1. Therefore, carriers generated not only in the first region R1 but also in the second region R2 and the non-depletion region may be collected. The first region R1 may be formed in a region overlapping with the high-concentration doping region 106 and the guard ring 108 along the third direction D3. For example, the first region R1 may be provided between the second region R2 and the first well 104. The first region R1 may extend to the region between the guard ring 108 and the relaxation region 112.

The second region R2 may be configured to multiply the charge transferred from the first region R1 and the charge generated in the second region R2. For example, during the operation of the single photon detection device SPD1, an electric field with a magnitude of 3×10⁵ V/cm or more may be applied to the second region R2. The second region R2 may be referred to as the multiplication region. The second region R2 may be formed between the high-concentration doping region 106 and the first region R1. For example, the second region R2 may be provided at and around the interface between the high-concentration doping region 106 and the first well 104. The second region R2 may overlap with the high-concentration doping region 106 along the third direction D3. The second region R2 may be provided between the guard ring 108 and the first well 104. The second region R2 may extend over the top of the guard ring 108 and over the interface of the first well 104. For example, the second region R2 may be formed on the top surface of the guard ring 108. The second region R2 may overlap with the guard ring 108 along the third direction D3. In some example embodiments, the second region R2 may overlap with a part of the guard ring 108 along the third direction D3. In some example embodiments, the second region R2 may overlap with the entire guard ring 108 along the third direction D3. The second region R2 may be provided between the high-concentration doping region 106 and the first region R1 and between the guard ring 108 and the first region R1. The second region R2 may overlap with the first region R1 along the third direction D3.

If the second region R2 is formed only in the inner region of the guard ring 108, the amount of charge generated by light incident on the first well 104 and substrate region 102 that is not multiplied may be relatively large. The inner region of the guard ring 108 may refer to the region surrounded by the guard ring 108 from a plan view perspective. This disclosure provides that the second region R2 is formed not only in the inner region of the guard ring 108 (i.e., the region overlapping with the high-concentration doping region 106 along the third direction D3) but also on the top surface of the guard ring 108, so that a relatively large amount of charges can be multiplied. Accordingly, the efficiency of the light detection layer 10 can be improved.

The contact region 110 may be provided on the side of the guard ring 108. The contact region 110 may be provided on the opposite side of the high-concentration doping region 106 with the guard ring 108 in between. The contact region 110 may be exposed on the frontside surface 100a. On the frontside surface 100a, the contact region 110 may surround the guard ring 108. In some example embodiments, the contact region 110 may be provided in multiple numbers. In some example embodiments, the multiple contact regions may be electrically connected to circuits outside the light detection layer 10, respectively. The contact region 110 may have the first conductivity type. The doping concentration of the contact region 110 may be higher than the doping concentration of the first well 104. For example, the doping concentration of the contact region 110 may be 1×10¹⁵ to 2×10²¹ cm⁻³. In some example embodiments, the contact region 110 may be electrically connected to at least one of an external power source, a DC-DC converter, and other power management integrated circuits. In some example embodiments, the contact region 110 may be electrically connected to at least one of a quenching resistor (or quenching circuit) and other pixel circuits.

The relaxation region 112 may be provided between the contact region 110 and the first well 104. The relaxation region 112 may be electrically connected to the contact region 110 and the first well 104. The relaxation region 112 may improve the electrical connection characteristics between the contact region 110 and the first well 104. For example, the relaxation region 112 may be configured to reduce or prevent voltage drop when voltage is applied to the first well 104 through the contact region 110, and to ensure that voltage is uniformly applied to the first well 104. The relaxation region 112 may extend along the contact region 110. The relaxation region 112 may be provided on one side surface and the top surface of the contact region 110. For example, the relaxation region 112 may directly contact one side surface and the top surface of the contact region 110. The top surface and one side surface of the relaxation region 112 may contact the first well 104. The other side surface of the relaxation region 112 may contact the substrate region 102. In some example embodiments, the relaxation region 112 may protrude from the side of the first well 104. The relaxation region 112 may be exposed on the frontside surface 100a. On the frontside surface 100a, the relaxation region 112 may surround the guard ring 108. The relaxation region 112 may be spaced apart from the guard ring 108. The first well 104 may extend between the relaxation region 112 and the guard ring 108. For example, the region between the relaxation region 112 and the guard ring 108 may be filled with the first well 104. Between the relaxation region 112 and the guard ring 108, the first well 104 may be exposed on the frontside surface 100a. The relaxation region 112 may have the first conductivity type. The doping concentration of the relaxation region 112 may be lower than the doping concentration of the contact region 110 and similar to or higher than the doping concentration of the first well 104. For example, the doping concentration of the relaxation region 112 may be 1×10¹⁵ to 5×10¹⁷ cm⁻³.

The device isolation pattern 114 may be provided on the other side surface of the relaxation region 112. The device isolation pattern 114 may be exposed on the frontside surface 100a. On the frontside surface 100a, the device isolation pattern 114 may surround the relaxation region 112. The device isolation pattern 114 may include an electrically insulating material. For example, the device isolation pattern 114 may include silicon oxide (e.g., SiO₂), silicon nitride (e.g., SiN), silicon oxynitride (e.g., SiON), or a combination thereof. The device isolation pattern 114 may be formed, for example, by a process of filling an electrically insulating material into a recess region formed by etching the semiconductor substrate 100. For example, the device isolation pattern 114 may be STI (shallow trench isolation). The device isolation pattern 114 may electrically isolate the light detection layer 10 and other semiconductor devices (e.g., other light detection layers 10 or electronic devices constituting other circuits (e.g., transistors)). Although it is illustrated that the device isolation pattern 114 contacts the contact region 110 and the relaxation region 112, this is exemplary. In some example embodiments, the device isolation pattern 114 may be spaced apart from the contact region 110 and the relaxation region 112.

The control layer 20 may be provided on the frontside surface 100a of the substrate 100. The control layer 20 may include circuits necessary for the operation of the light detection layer 10. For example, the control layer 20 may be in the form of a separate chip with circuits formed. The circuits may be implemented by various electronic devices as needed. The circuits may include quenching resistors (or quenching circuits) and pixel circuits. The quenching resistor (or quenching circuit) may be configured to stop the avalanche effect and allow the light detection layer 10 to detect another photon. The pixel circuit may consist of reset or recharge circuits, memory, amplification circuits, counters, gate circuits, time-to-digital converters, etc. Also, the circuits may include DC-DC converters and other power management integrated circuits. The circuits may transmit signals to the light detection layer 10 or receive signals from the light detection layer 10. Specifically, the circuits of the control layer 20 may be electrically connected to the output pattern 302a and the bias pattern 302b, and electrical signals may be transmitted/received through electrodes (e.g., Through-Silicon Via) penetrating from the backside surface 100b to the frontside surface 100a of the substrate 100.

The connection layer 30 may be provided between the light detection layer 10 and the control layer 20. The connection layer 30 may include an insulating layer 306, a first silicide layer SL1, a second silicide layer SL2, an output pattern 302a, a bias pattern 302b, a shield pattern 302c, and vertical connections 304. For example, the insulating layer 306 may include silicon oxide (e.g., SiO₂), silicon nitride (e.g., SiN), silicon oxynitride (e.g., SiON), or a combination thereof. For example, the vertical connections 304 may include contacts or vias.

The first silicide layer SL1 may be provided between the high-concentration doping region 106 and the vertical connections 304. The first silicide layer SL1 may extend over the guard ring 108. In some example embodiments, the first silicide layer SL1 may be formed horizontally up to substantially the same position as the outer side surface of the guard ring 108, completely covering the bottom surface of the guard ring 108. For example, the side surface of the first silicide layer SL1 may be coplanar with the outer side surface of the guard ring 108. In some other example embodiments, the first silicide layer SL1 may be formed horizontally up to the inside of the outer side surface of the guard ring 108, partially covering the bottom surface of the guard ring 108. For example, the side surface of the first silicide layer SL1 may be shifted inward from the outer side surface of the guard ring 108. The first silicide layer SL1 may be electrically connected to the high-concentration doping region 106, the guard ring 108, and the vertical connections 304. For example, the first silicide layer SL1 may directly contact the high-concentration doping region 106, the guard ring 108, and the vertical connections 304. The first silicide layer SL1 may improve the electrical connection characteristics between the high-concentration doping region 106, the guard ring 108, and the vertical connections 304. For example, the first silicide layer SL1 may reduce the contact resistance between the high-concentration doping region 106 and the vertical connections 304. The first silicide layer SL1 may reduce or prevent voltage drop when voltage is applied to the high-concentration doping region 106 and the guard ring 108 through the first silicide layer SL1. The first silicide layer SL1 may be configured to ensure that voltage is uniformly applied to the high-concentration doping region 106 and the guard ring 108. The first silicide layer SL1 and the high-concentration doping region 106 may form a Schottky junction. For example, the first silicide layer SL1 may include at least one of chromium silicide (CrSi), manganese silicide (MnSi), iron silicide (FeSi), cobalt silicide (CoSi), nickel silicide (NiSi), sodium silicide (NaSi), magnesium silicide (Mg₂Si), platinum silicide (PtSi), titanium silicide (TiSi₂), tungsten silicide (WSi₂), molybdenum silicide (MoSi₂), neodymium silicide (NdSi), strontium silicide (SrSi₂), thorium silicide (ThSi₂), uranium silicide (USi), hafnium silicide (HfSi₂), and neodymium silicide (NdSi₂).

The second silicide layer SL2 may be provided between the contact region 110 and the vertical connections 304. In some example embodiments, the second silicide layer SL2 may be formed only on the contact region 110. In some other example embodiments, the second silicide layer SL2 may extend over the first well 104, partially covering the exposed bottom surface of the first well 104 between the contact region 110 and the guard ring 108. The second silicide layer SL2 may be electrically connected to the contact region 110 and the vertical connections 304. For example, the second silicide layer SL2 may directly contact the contact region 110 and the vertical connections 304. The second silicide layer SL2 may improve the electrical connection characteristics between the contact region 110 and the vertical connections 304. For example, the second silicide layer SL2 may reduce the contact resistance between the contact region 110 and the vertical connections 304. The second silicide layer SL2 may reduce or prevent voltage drop when voltage is applied to the contact region 110 through the second silicide layer SL2. The second silicide layer SL2 may be configured to ensure that voltage is uniformly applied to the contact region 110. The second silicide layer SL2 may include at least one of chromium silicide (CrSi), manganese silicide (MnSi), iron silicide (FeSi), cobalt silicide (CoSi), nickel silicide (NiSi), sodium silicide (NaSi), magnesium silicide (Mg₂Si), platinum silicide (PtSi), titanium silicide (TiSi₂), tungsten silicide (WSi₂), molybdenum silicide (MoSi₂), neodymium silicide (NdSi), strontium silicide (SrSi₂), thorium silicide (ThSi₂), uranium silicide (USi), hafnium silicide (HfSi₂), and neodymium silicide (NdSi₂).

The first well 104 may be exposed between the first silicide layer SL1 and the second silicide layer SL2. If the first silicide layer SL1 extends over the first well 104, electrical shorting may occur between the first silicide layer SL1 and the second silicide layer SL2. This disclosure provides that the first silicide layer SL1 and the second silicide layer SL2 can be sufficiently spaced apart to prevent electrical shorting between them.

Light with energy smaller than the bandgap energy of the substrate 100 (e.g., light with wavelengths of 1100 nm to 1600 nm for a silicon substrate) may pass through the light detection layer 10 without being absorbed. As the first silicide layer SL1 and the high-concentration doping region 106 form a Schottky junction, a Schottky barrier may be formed between the first silicide layer SL1 and the high-concentration doping region 106. During the operation of the single photon detection device SPD1, the height of the Schottky barrier between the first silicide layer SL1 and the substrate 100 may be determined to be smaller than the bandgap energy of the substrate 100. For example, the material constituting the first silicide layer SL1 may be selected so that the height of the Schottky barrier between the first silicide layer SL1 and the substrate 100 is smaller than the bandgap energy of the substrate 100. Long-wavelength light (e.g., light with wavelengths of 1100 nm to 1600 nm) passing through the substrate 100 may excite carriers into the substrate 100. Carriers excited from the first silicide layer SL1 into the substrate 100 may be referred to as hot carriers. Hot carriers may move to the second region R2 (i.e., the multiplication region) by the electric field and be multiplied in the second region R2. Accordingly, the single photon detection device SPD1 can detect long-wavelength light that is not absorbed by the substrate 100.

The optical absorption efficiency of the substrate 100 for light with energy equal to or greater than the bandgap energy of the substrate 100 may be higher the longer the optical path length within the substrate 100. The first silicide layer SL1 and the second silicide layer SL2 may reflect light passing through the light detection layer 10 (i.e., light with energy equal to or greater than the bandgap energy of the substrate 100) back into the light detection layer 10. Accordingly, the optical absorption efficiency of the substrate 100 for light with energy equal to or greater than the bandgap energy of the substrate 100 can be improved.

The output pattern 302a may be electrically connected to the high-concentration doping region 106 through the vertical connections 304 and the first silicide layer SL1. The output pattern 302a may be configured to extract detection signals from the light detection layer 10. The output pattern 302a may include an electrically conductive material. For example, the output pattern 302a may include copper (Cu), aluminum (Al), tungsten (W), titanium (Ti), titanium nitride (TiN), or a combination thereof. The output pattern 302a and the required circuits in the control layer 20 may be electrically connected by conductive lines provided between them. The output pattern 302a may transmit detection signals extracted from the light detection layer 10 to the control layer 20.

The bias pattern 302b may be electrically connected to the contact region 110 through the vertical connections 304 and the second silicide layer SL2. The bias pattern 302b may be configured to apply a bias to the light detection layer 10. The bias pattern 302b may include an electrically conductive material. For example, the bias pattern 302b may include copper (Cu), aluminum (Al), tungsten (W), titanium (Ti), titanium nitride (TiN), or a combination thereof. The bias pattern 302b and the required circuits in the control layer 20 may be electrically connected by conductive lines provided between them. The bias pattern 302b may be configured to apply a bias provided from the control layer to the light detection layer 10.

If the output pattern 302a is used as a reflection layer for light passing through the light detection layer 10 instead of the first silicide layer SL1, the output pattern 302a may have a relatively large region to reflect light over a wide region. This disclosure uses the first silicide layer SL1 as a reflection layer, so the output pattern 302a can be configured to have a small region. Accordingly, the separation distance between the output pattern 302a and the bias pattern 302b can be increased, and the parasitic capacitance between the output pattern 302a and the bias pattern 302b can be reduced.

The shield pattern 302c may electrically shield between the output pattern 302a and the bias pattern 302b. For example, the shield pattern 302c may be configured so that the detection signal extracted by the output pattern 302a is not affected by the bias signal applied to the bias pattern 302b. For example, the shield pattern 302c between the output pattern 302a and the bias pattern 302b may be electrically isolated from the output pattern 302a and the bias pattern 302b. For example, the shield pattern 302c may be spaced apart from the output pattern 302a and the bias pattern 302b.

The optical element layer 40 may be provided on the backside surface 100b of the substrate 100. The optical element layer 40 is a component for effectively detecting incident light in the light detection layer 10 by refracting, diffracting, or scattering the path of incident light. The optical element layer 40 may include a lens 402. The lens 402 may focus incident light and transmit the incident light to the light detection layer 10. For example, the lens 402 may include a microlens, a Fresnel lens, or a metalens. However, the type of lens 402 is not limited and may be determined as needed. In some example embodiments, the central axis of the lens 402 may be aligned with the central axis of the light detection layer 10. The central axes of the lens 402 and the light detection layer 10 may be virtual axes passing through the centers of the lens 402 and the light detection layer 10, respectively, and parallel to the stacking direction of the light detection layer 10 and the lens 402 (i.e., the opposite direction of the third direction D3). In some example embodiments, the central axis of the lens 402 may be misaligned with the central axis of the light detection layer 10. In some example embodiments, the width of the lens 402 may be about half the width of the light detection layer 10. In some example embodiments, the lenses 402 may be arranged in a 2×2 pattern. In some example embodiments, the optical element layer 40 may further include at least one optical element between the lens 402 and the light detection layer 10. For example, the optical element may be a color filter, a bandpass filter, a metal grid, an air grid, a low refractive index material-based grid, an anti-reflection coating, a 2D nanomaterial layer, or an organic material layer. In some example embodiments, the anti-reflection coating may be formed on the lens 402.

If the second region R2 is formed only in the inner region of the guard ring 108, the amount of charge generated by light incident on the first well 104 and substrate region 102 that is not multiplied may be relatively large. The inner region of the guard ring 108 may refer to the region surrounded by the guard ring 108 from a plan view perspective. This disclosure provides that the second region R2 is formed not only in the inner region of the guard ring 108 (i.e., the region overlapping with the high-concentration doping region 106 along the third direction D3) but also on the top surface of the guard ring 108, so that a relatively large amount of charges can be multiplied. Accordingly, the light detection efficiency of the light detection layer 10 can be improved.

This disclosure can provide a single photon detection device SPD1 with improved electrical characteristics and optical absorption efficiency and increased light detection wavelength range by using the first silicide layer SL1 and the second silicide layer SL2.

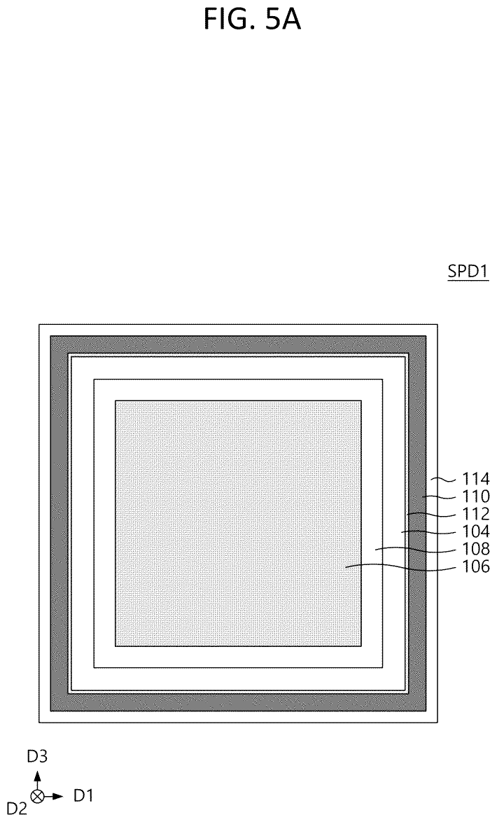

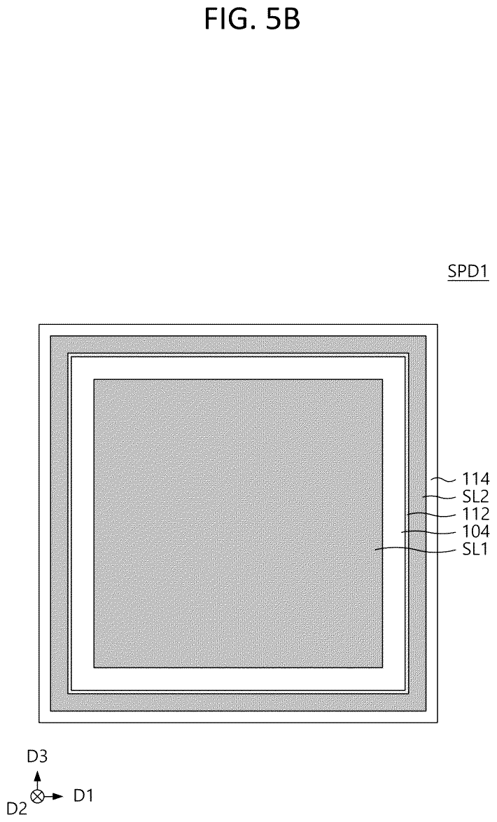

FIG. 5A is a plan view of the single photon detection device of FIG. 2 according to some example embodiments. FIG. 5B is a plan view for explaining the first silicide layer and the second silicide layer. For brevity of explanation, differences from those illustrated in FIG. 1 are explained.

Referring to FIGS. 5A and 5B, a single photon detection device SPD1 may be provided. Unlike those illustrated in FIG. 1, the high-concentration doping region 106 may have a square shape, and the guard ring 108, first well 104, relaxation region 112, contact region 110, and device isolation pattern 114 may have square ring shapes surrounding the high-concentration doping region 106. The guard ring 108, first well 104, relaxation region 112, contact region 110, and device isolation pattern 114 may be arranged in order moving away from the high-concentration doping region 106. For example, the guard ring 108, first well 104, relaxation region 112, contact region 110, and device isolation pattern 114 may have the same center.

Unlike those illustrated in FIG. 2, the first silicide layer SL1 may have a square shape, and the second silicide layer SL2 may have a square ring shape surrounding the first silicide layer SL1.

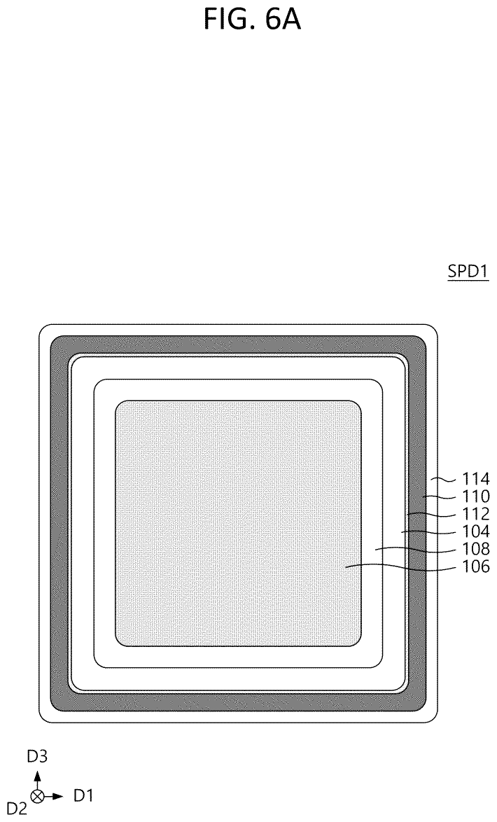

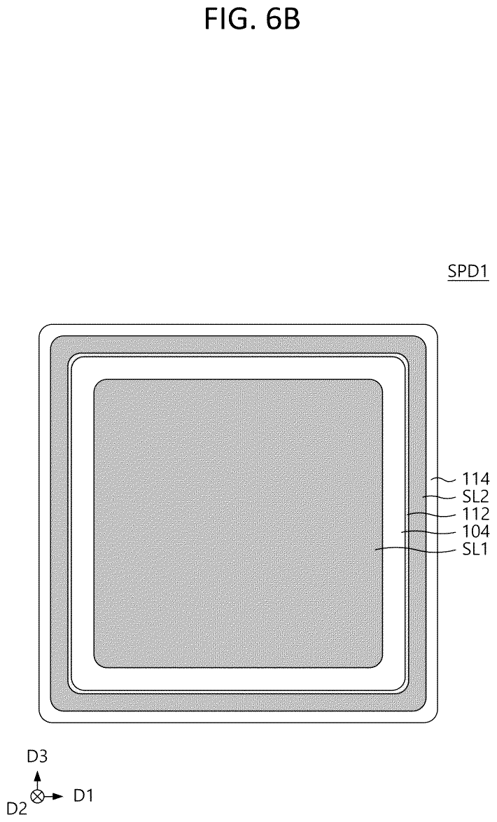

FIG. 6A is a plan view of the single photon detection device of FIG. 2 according to some example embodiments. FIG. 6B is a plan view for explaining the first silicide layer and the second silicide layer. For brevity of explanation, differences from those illustrated in FIG. 1 are explained.

Referring to FIGS. 6A and 6B, a single photon detection device SPD1 may be provided. Unlike those illustrated in FIG. 1, the high-concentration doping region 106 may have a rounded square shape, and the guard ring 108, first well 104, relaxation region 112, contact region 110, and device isolation pattern 114 may have rounded square ring shapes surrounding the high-concentration doping region 106. The guard ring 108, first well 104, relaxation region 112, contact region 110, and device isolation pattern 114 may be arranged in order moving away from the high-concentration doping region 106. For example, the high-concentration doping region 106, guard ring 108, first well 104, relaxation region 112, contact region 110, and device isolation pattern 114 may have the same center.

Unlike those illustrated in FIG. 2, the first silicide layer SL1 may have a rounded square shape, and the second silicide layer SL2 may have a rounded square ring shape surrounding the first silicide layer SL1.

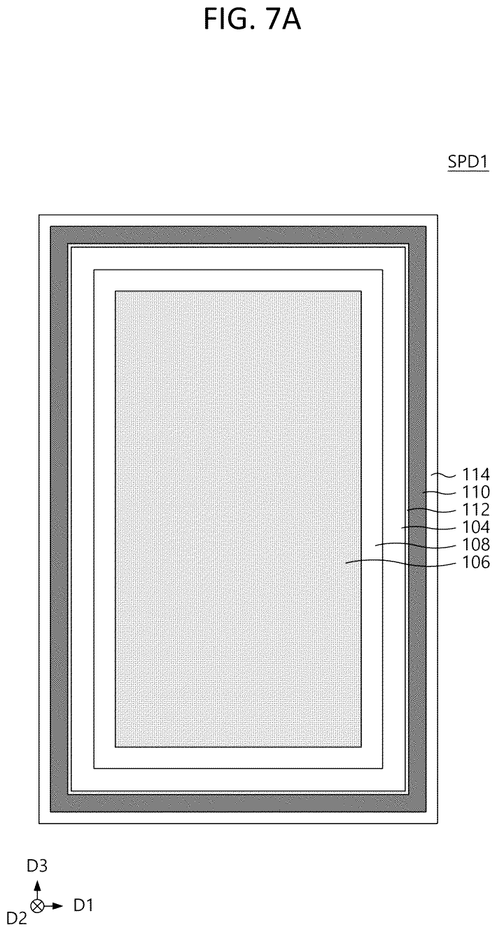

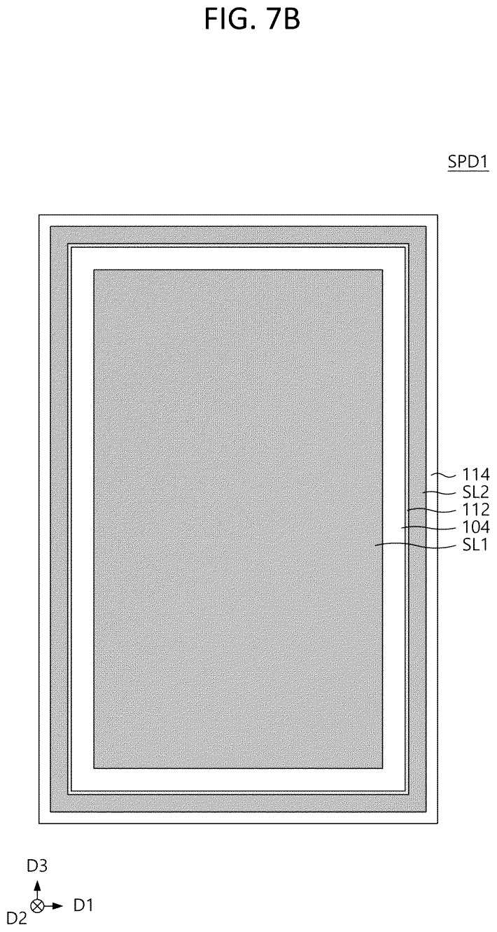

FIG. 7A is a plan view of the single photon detection device of FIG. 2 according to some example embodiments. FIG. 7B is a plan view for explaining the first silicide layer and the second silicide layer. For brevity of explanation, differences from those illustrated in FIG. 1 are explained.

Referring to FIGS. 7A and 7B, a single photon detection device SPD1 may be provided. Unlike those illustrated in FIG. 1, the high-concentration doping region 106 may have a rectangular shape (excluding square shape), and the guard ring 108, first well 104, relaxation region 112, contact region 110, and device isolation pattern 114 may have rectangular ring shapes (excluding square ring shape) surrounding the high-concentration doping region 106. The guard ring 108, first well 104, relaxation region 112, contact region 110, and device isolation pattern 114 may be arranged in order moving away from the high-concentration doping region 106. For example, the high-concentration doping region 106, guard ring 108, first well 104, relaxation region 112, contact region 110, and device isolation pattern 114 may have the same center.

Unlike those illustrated in FIG. 2, the first silicide layer SL1 may have a rectangular shape (excluding square shape), and the second silicide layer SL2 may have a rectangular ring shape (excluding square ring shape) surrounding the first silicide layer SL1.

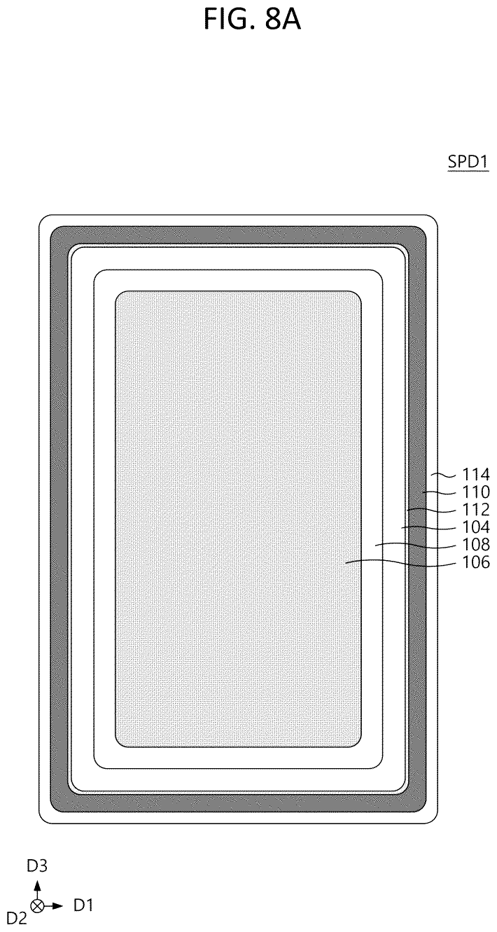

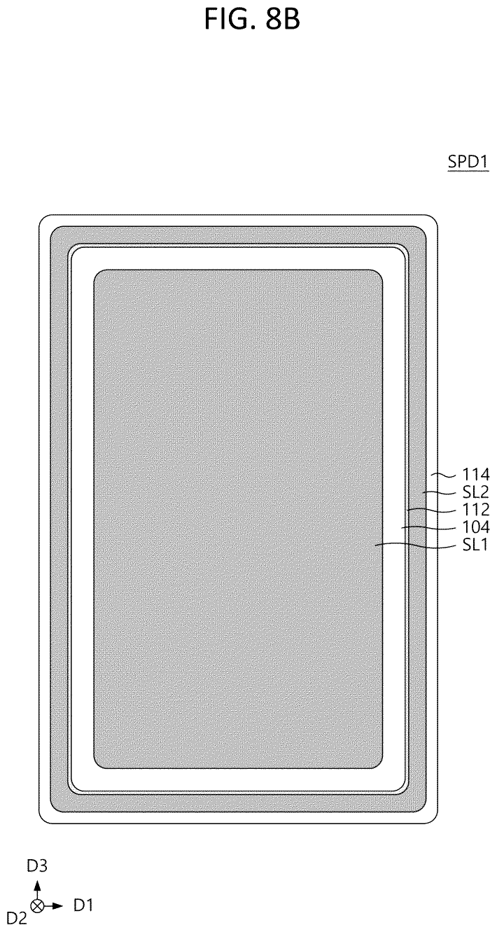

FIG. 8A is a plan view of the single photon detection device of FIG. 2 according to some example embodiments. FIG. 8B is a plan view for explaining the first silicide layer and the second silicide layer. For brevity of explanation, differences from those illustrated in FIG. 1 are explained.

Referring to FIGS. 8A and 8B, a single photon detection device SPD1 may be provided. Unlike those illustrated in FIG. 1, the high-concentration doping region 106 may have a rounded rectangular shape (excluding rounded square shape), and the guard ring 108, first well 104, relaxation region 112, contact region 110, and device isolation pattern 114 may have rounded rectangular ring shapes (excluding rounded square ring shape) surrounding the high-concentration doping region 106. The guard ring 108, first well 104, relaxation region 112, contact region 110, and device isolation pattern 114 may be arranged in order moving away from the high-concentration doping region 106. For example, the high-concentration doping region 106, guard ring 108, first well 104, relaxation region 112, contact region 110, and device isolation pattern 114 may have the same center.

Unlike those illustrated in FIG. 2, the first silicide layer SL1 may have a rounded rectangular shape (excluding rounded square shape), and the second silicide layer SL2 may have a rounded rectangular ring shape (excluding rounded square ring shape) surrounding the first silicide layer SL1.

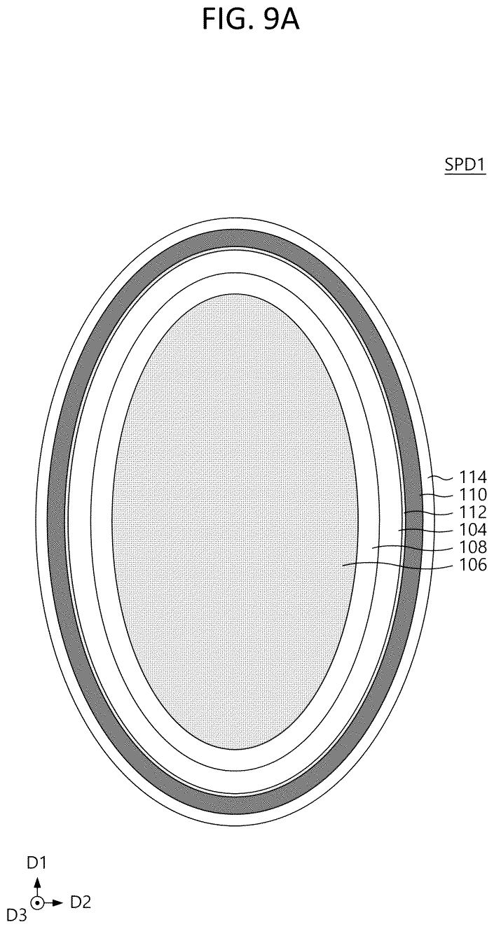

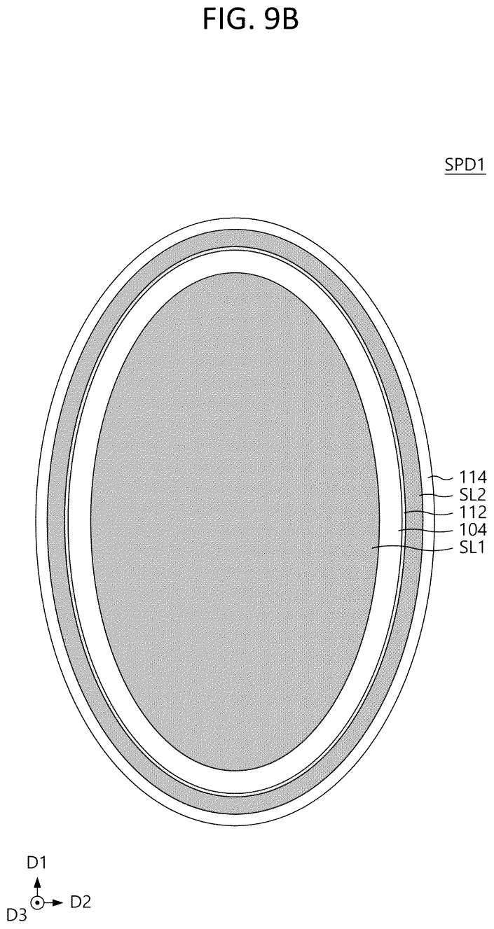

FIG. 9A is a plan view of the single photon detection device of FIG. 2 according to some example embodiments. FIG. 9B is a plan view for explaining the first silicide layer and the second silicide layer. For brevity of explanation, differences from those illustrated in FIG. 1 are explained.

Referring to FIGS. 9A and 9B, a single photon detection device SPD1 may be provided. Unlike those illustrated in FIG. 1, the high-concentration doping region 106 may have an elliptical shape, and the guard ring 108, relaxation region 112, first well 104, contact region 110, and device isolation pattern 114 may have elliptical ring shapes surrounding the high-concentration doping region 106. The guard ring 142, relaxation region 112, first well 104, contact region 110, and device isolation pattern 114 may be arranged in order moving away from the high-concentration doping region 106. For example, the high-concentration doping region 106, guard ring 108, first well 104, relaxation region 112, contact region 110, and device isolation pattern 114 may have the same center.

Unlike those illustrated in FIG. 2, the first silicide layer SL1 may have an elliptical shape, and the second silicide layer SL2 may have an elliptical ring shape surrounding the first silicide layer SL1.

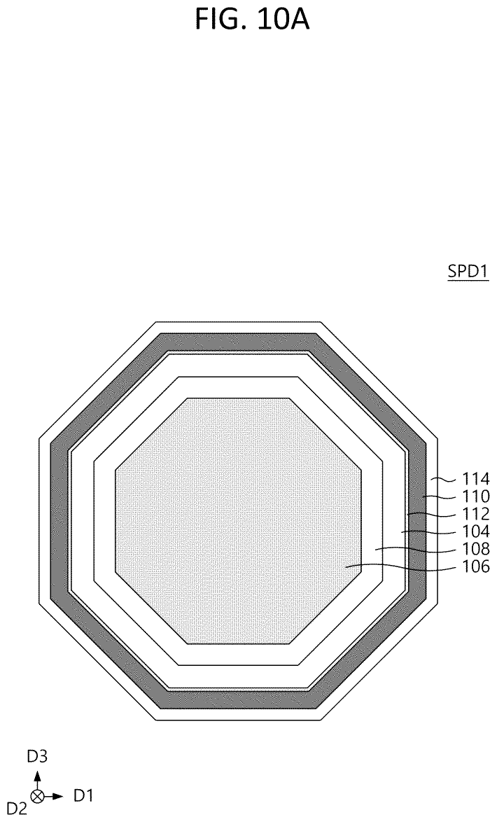

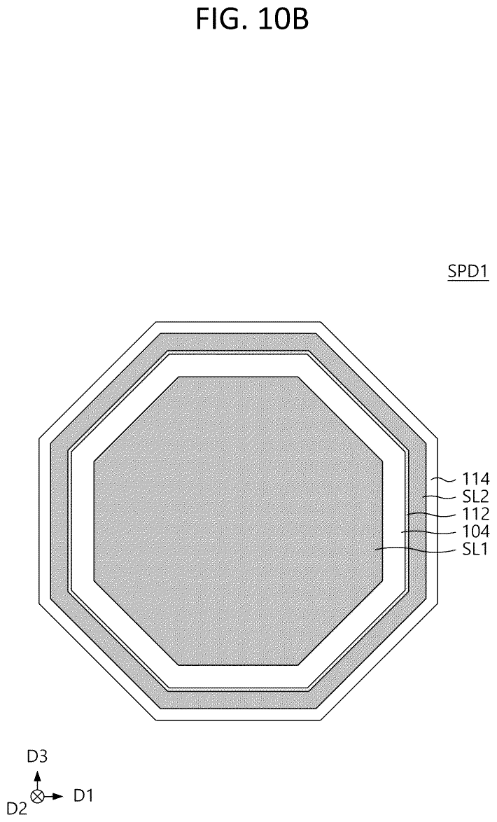

FIG. 10A is a plan view of the single photon detection device of FIG. 2 according to some example embodiments. FIG. 10B is a plan view for explaining the first silicide layer and the second silicide layer. For brevity of explanation, differences from those illustrated in FIG. 1 are explained.

Referring to FIGS. 10A and 10B, a single photon detection device SPD1 may be provided. Unlike those illustrated in FIG. 1, the high-concentration doping region 106 may have an octagonal shape, and the guard ring 108, relaxation region 112, first well 104, contact region 110, and device isolation pattern 114 may have octagonal ring shapes surrounding the high-concentration doping region 106. The guard ring 142, relaxation region 112, first well 104, contact region 110, and device isolation pattern 114 may be arranged in order moving away from the high-concentration doping region 106. For example, the high-concentration doping region 106, guard ring 108, first well 104, relaxation region 112, contact region 110, and device isolation pattern 114 may have the same center.

Unlike those illustrated in FIG. 2, the first silicide layer SL1 may have an octagonal shape, and the second silicide layer SL2 may have an octagonal ring shape surrounding the first silicide layer SL1.

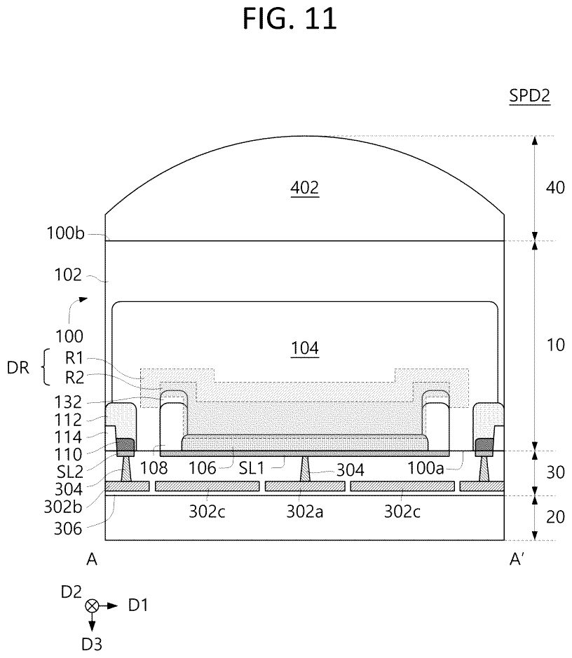

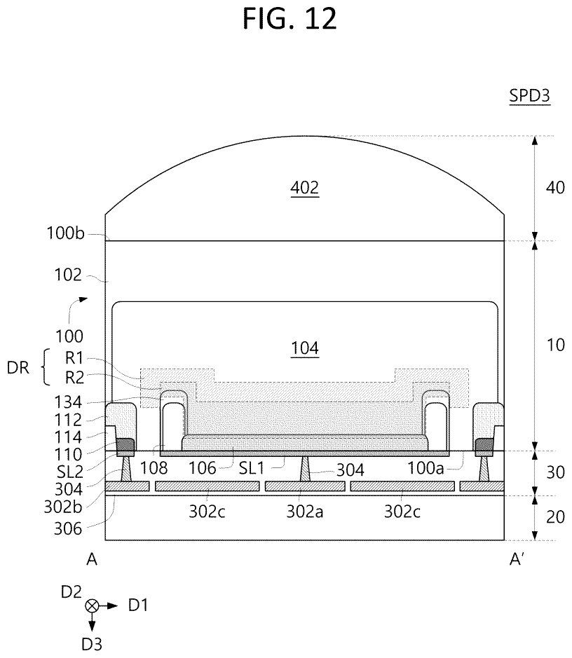

FIGS. 11 and 12 are cross-sectional views corresponding to the A-A′ line of FIG. 1. For brevity of explanation, differences from what is explained with reference to FIGS. 1 to 4 are explained.

Referring to FIG. 11, a single photon detection device SPD2 may be provided. Unlike those illustrated in FIGS. 1 to 3, the single photon detection device SPD2 may include a first additional guard ring 132. The first additional guard ring 132 may be provided on the top surface of the guard ring 108. In some example embodiments, the side surface of the first additional guard ring 132 may be aligned with the side surface of the guard ring 108. For example, the side surface of the first additional guard ring 132 and the side surface of the guard ring 108 may be coplanar. The first additional guard ring 132 may have the same conductivity type as the guard ring 108 and the high-concentration doping region 106. The first additional guard ring 132 may have the second conductivity type. For example, the doping concentration of the first additional guard ring 132 may be 1×10¹⁵ to 1×10¹⁸ cm⁻³. In some example embodiments, the first additional guard ring 132 may have a different doping concentration from the guard ring 108. The first additional guard ring 132 may reduce or prevent the occurrence of premature breakdown along with the guard ring 108.

Referring to FIG. 12, a single photon detection device SPD3 may be provided. Unlike those illustrated in FIGS. 1 to 3, the single photon detection device SPD3 may include a second additional guard ring 134. The second additional guard ring 134 may extend from the region on the top surface of the guard ring 108 to the regions on the inner side surface and outer side surface of the guard ring 108. For example, the second additional guard ring 134 may cover the inner side surface and outer side surface of the guard ring 108. The guard ring 108 may be spaced apart from the first well 104 by the second additional guard ring 134.

The second additional guard ring 134 may have the same conductivity type as the guard ring 108 and the high-concentration doping region 106. The second additional guard ring 134 may have the second conductivity type. For example, the doping concentration of the second additional guard ring 134 may be 1×10¹⁵ to 1×10¹⁸ cm⁻³. In some example embodiments, the second additional guard ring 134 may have a different doping concentration from the guard ring 108. The second additional guard ring 134 may reduce or prevent the occurrence of premature breakdown along with the guard ring 108.

The first silicide layer SL1 may extend over the second additional guard ring 134. For example, the first silicide layer SL1 may contact the bottom surface of the second additional guard ring 134.

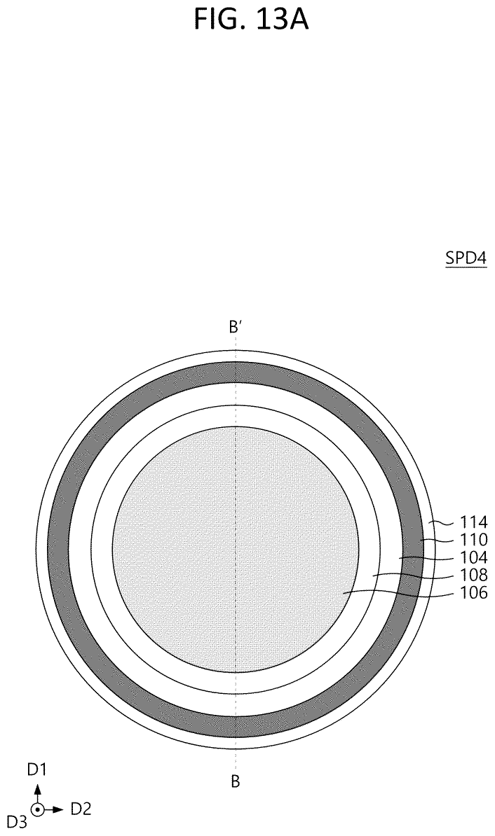

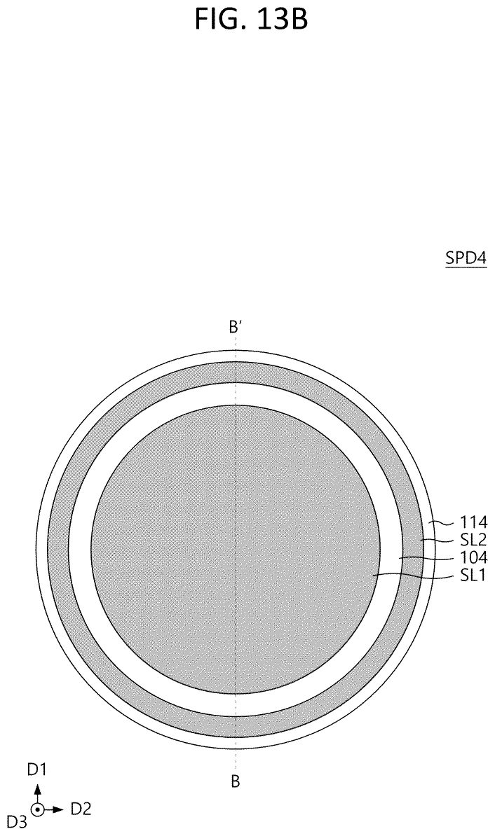

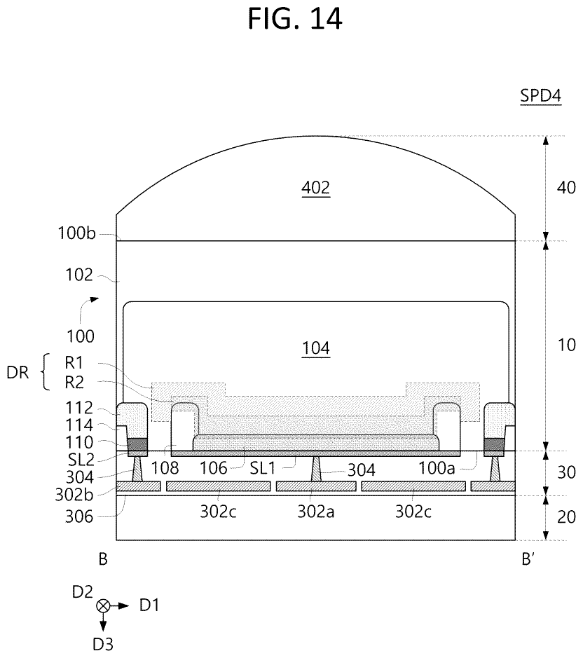

FIG. 13A is a plan view of a single photon detection device according to some example embodiments. FIG. 13B is a plan view for explaining the first silicide layer and the second silicide layer. FIG. 14 is a cross-sectional view along the B-B′ line of FIG. 13A. For brevity of explanation, differences from what is explained with reference to FIGS. 1 to 4 are explained.

Referring to FIGS. 13A to 14, a single photon detection device SPD4 may be provided. Unlike those illustrated in FIGS. 1 to 3, the inner side surface of the contact region 110 may be aligned with the inner side surface of the relaxation region 112. For example, the inner side surface of the contact region 110 and the inner side surface of the relaxation region 112 may be coplanar. The inner side surface of the contact region 110 may directly contact the first well 104. The outer side surface of the contact region 110 may directly contact the device isolation region 114. The top surface of the contact region 110 may directly contact the relaxation region 112.

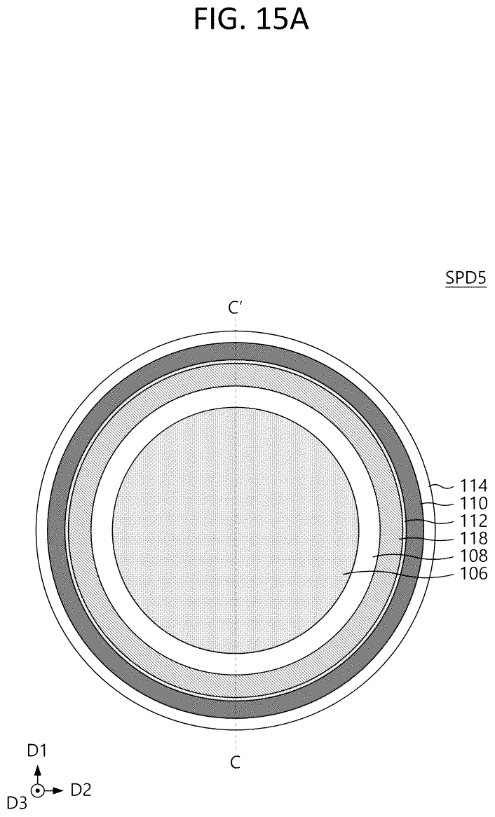

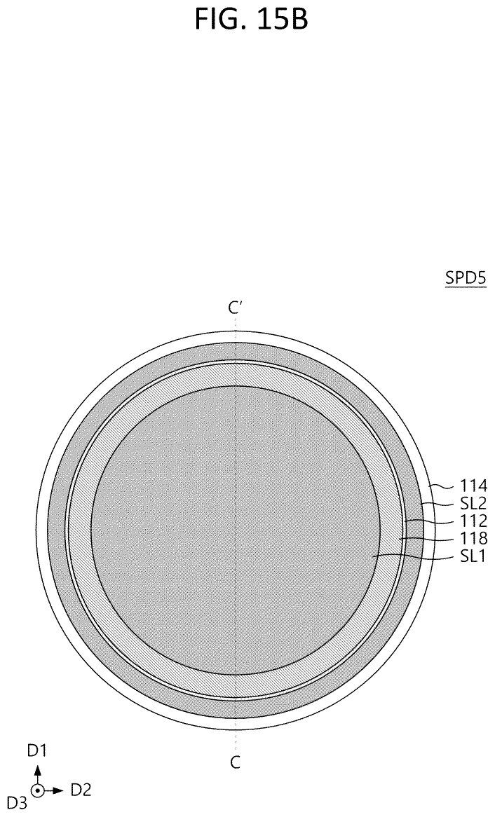

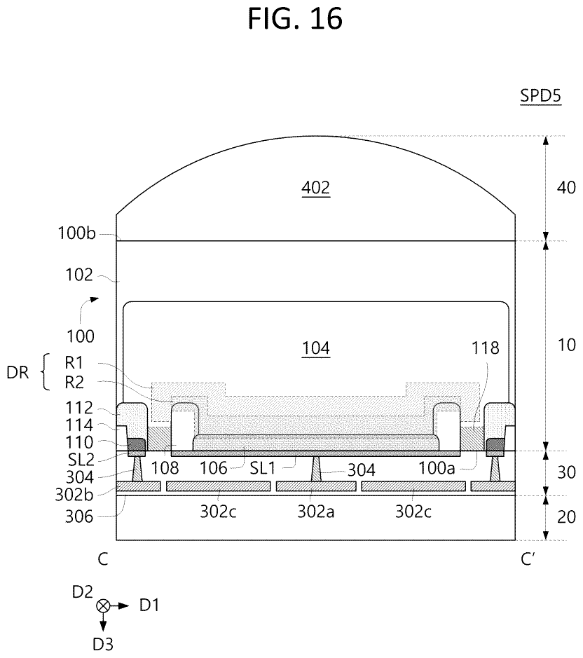

FIG. 15A is a plan view of a single photon detection device according to some example embodiments. FIG. 15B is a plan view for explaining the first silicide layer and the second silicide layer. FIG. 16 is a cross-sectional view along the C-C′ line of FIG. 15A. For brevity of explanation, differences from what is explained with reference to FIGS. 1 to 4 are explained.

Referring to FIGS. 15A to 16, a single photon detection device SPD5 may be provided. Unlike those illustrated in FIGS. 1 to 3, the single photon detection device SPD5 may include a virtual guard ring 118. The virtual guard ring 118 may be formed between the guard ring 108 and the relaxation region 112. The virtual guard ring 118 may be a part of the first well 104 or the substrate region 102. For example, the virtual guard ring 118 may be formed as the doping concentration of the first well 104 decreases closer to the frontside surface 100a. The virtual guard ring 118 may be configured to act as an additional guard ring. Specifically, the virtual guard ring 118 may mitigate the concentration of electric field in a portion of the depletion region DR, thereby preventing premature breakdown. For example, the virtual guard ring 118 may be configured to mitigate the concentration of electric field in the second region R2 formed on the top surface of the guard ring 108. The breakdown characteristics of the single photon detection device SPD5 may be improved by the virtual guard ring 118. The virtual guard ring 118 may surround the guard ring 108. For example, the virtual guard ring 118 may have a ring shape extending along the region between the guard ring 108 and the relaxation region 112.

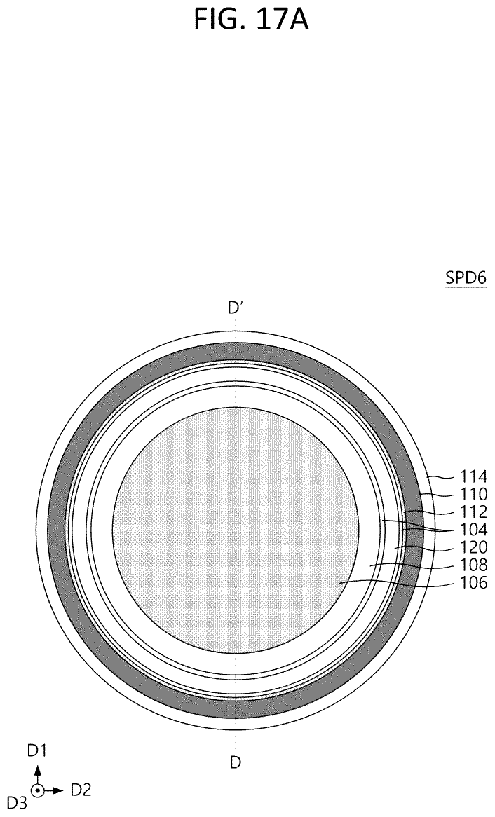

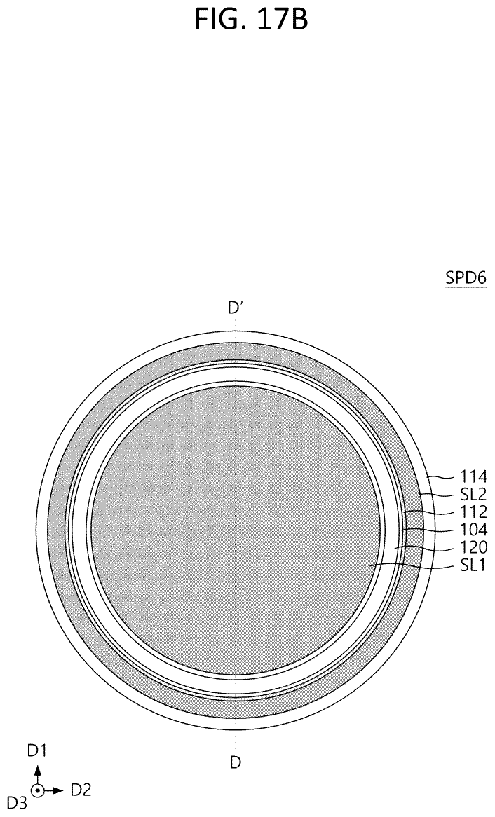

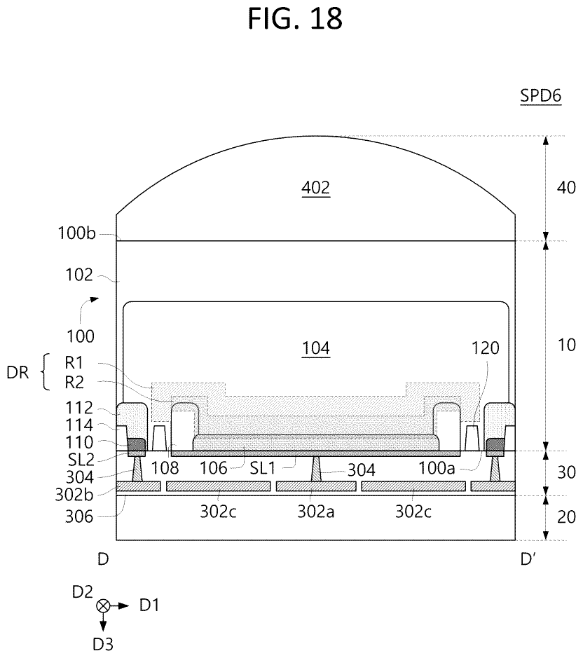

FIG. 17A is a plan view of a single photon detection device according to some example embodiments. FIG. 17B is a plan view for explaining the first silicide layer and the second silicide layer. FIG. 18 is a cross-sectional view along the D-D′ line of FIG. 17A. For brevity of explanation, differences from what is explained with reference to FIGS. 1 to 4 are explained.

Referring to FIGS. 17A to 18, a single photon detection device SPD6 may be provided. Unlike those illustrated in FIGS. 1 to 3, the single photon detection device SPD6 may include a first insulation pattern 120. The first insulation pattern 120 may be provided between the relaxation region 112 and the guard ring 108. The first insulation pattern 120 may be exposed on the frontside surface 100a. The bottom surface of the first insulation pattern 120 may be exposed between the first silicide layer SL1 and the second silicide layer SL2. On the frontside surface 100a, the first insulation pattern 120 may surround the guard ring 108. The first insulation pattern 120 may include an electrically insulating material. For example, the first insulation pattern 120 may include silicon oxide (e.g., SiO₂), silicon nitride (e.g., SiN), silicon oxynitride (e.g., SiON), or a combination thereof. The first insulation pattern 120 may be formed, for example, by a process of filling an electrically insulating material into a recess region formed by etching the semiconductor substrate 100. For example, the first insulation pattern 120 may be STI. The first insulation pattern 120 may be formed in the substrate 100 before the first well 104. For example, in the ion implantation process for implanting impurities to form the first well 104 in the substrate 100, the first insulation pattern 120 may be configured to lower the ion implantation effect on the region (first well 104) located between the second insulation pattern 122 and the backside surface 100b. Compared to the case without the first insulation pattern 120, when the first insulation pattern 120 is present, the doping concentration of a region of the first well 104 located below the first insulation pattern 120 may be lower. Accordingly, the depletion region DR (or the first region R1 and the second region R2) may be formed widely, and as a result, the fill factor and efficiency may be improved. This disclosure can provide a single photon detection device SPD6 with improved fill factor and efficiency.

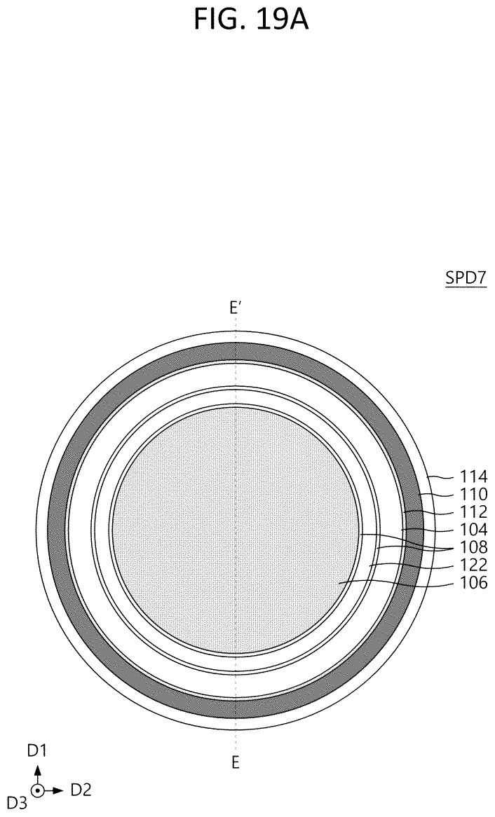

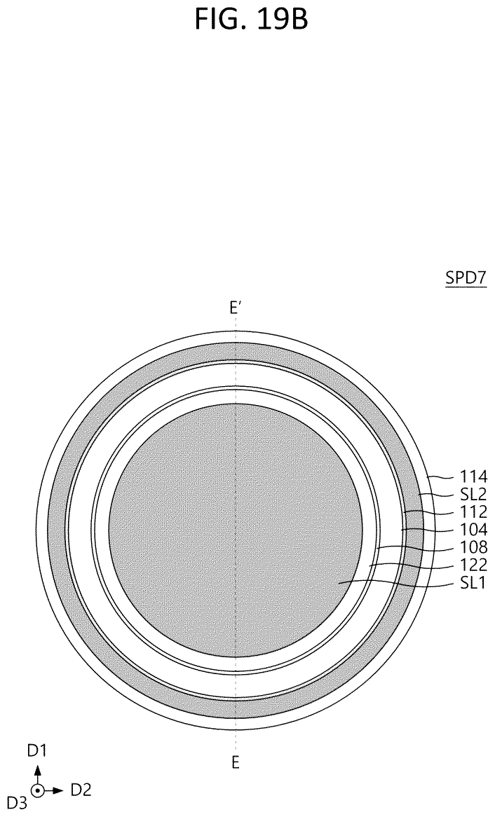

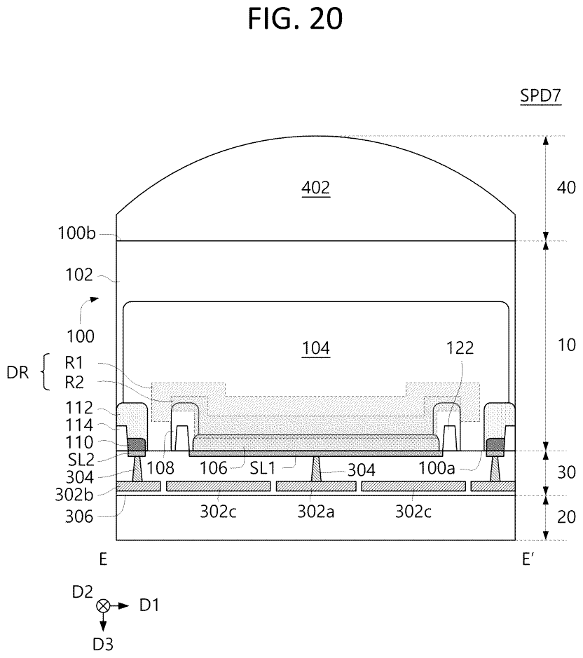

FIG. 19A is a plan view of a single photon detection device according to some example embodiments. FIG. 19B is a plan view for explaining the first silicide layer and the second silicide layer. FIG. 20 is a cross-sectional view along the E-E′ line of FIG. 19A. For brevity of explanation, differences from what is explained with reference to FIGS. 1 to 4 are explained.

Referring to FIGS. 19A to 20, a single photon detection device SPD7 may be provided. Unlike those illustrated in FIGS. 1 to 3, the single photon detection device SPD7 may include a second insulation pattern 122. The second insulation pattern 122 may be provided below the guard ring 108. The second insulation pattern 122 may overlap with the guard ring 108 along the third direction D3. The second insulation pattern 122 may surround the high-concentration doping region 106. For example, the second insulation pattern 122 may have a ring shape extending along the side of the high-concentration doping region 106. Although it is illustrated that the second insulation pattern 122 is spaced apart from the high-concentration doping region 106, this is exemplary. In some example embodiments, the second insulation pattern 122 may directly contact the high-concentration doping region 106. The second insulation pattern 122 may be formed from the same level as the bottom surface of the high-concentration doping region 106 to a certain depth. The depth of the second insulation pattern 122 may be determined as needed. The second insulation pattern 122 may be inserted into the guard ring 108. For example, the side surfaces and top surface of the second insulation pattern 122 may directly contact the guard ring 108. The bottom surface of the second insulation pattern 122 may be exposed on the bottom surface of the substrate 100. The bottom surface of the second insulation pattern 122 may be exposed between the first silicide layer SL1 and the second silicide layer SL2. The first silicide layer SL1 may cover the bottom surface of the guard ring 108 between the second insulation pattern 122 and the high-concentration doping region 106.

The second insulation pattern 122 may include an electrically insulating material. For example, the second insulation pattern 122 may include silicon oxide (e.g., SiO₂), silicon nitride (e.g., SiN), silicon oxynitride (e.g., SiON), or a combination thereof. In some example embodiments, the second insulation pattern 122 may be STI formed by etching a part of the semiconductor substrate and filling the etched region with an electrically insulating material. The second insulation pattern 122 may reduce or prevent the concentration of electric field in a portion of the depletion region DR, thereby reducing or preventing premature breakdown. The second insulation pattern 122 may reduce or prevent the influence of surface noise components. The second insulation pattern 122 may be formed in the substrate 100 before the first well 104 and the guard ring 108. The second insulation pattern 122 may reduce the doping concentration of the region located between the second insulation pattern 122 and the backside surface 100b. For example, in the ion implantation process for implanting impurities to form the first well 104 and the guard ring 108 in the substrate 100, the second insulation pattern 122 may be configured to lower the ion implantation effect on the region where the first well 104 and the guard ring 108 are formed. Compared to the case without the second insulation pattern 122, when the second insulation pattern 122 is present, the doping concentration of the first well 104 and the guard ring 108 located above the second insulation pattern 122 may be lower. Accordingly, if the depletion region DR (or the first region R1 and the second region R2) is formed widely, the fill factor and efficiency may be improved. This disclosure can provide a single photon detection device SPD7 with improved fill factor and efficiency.

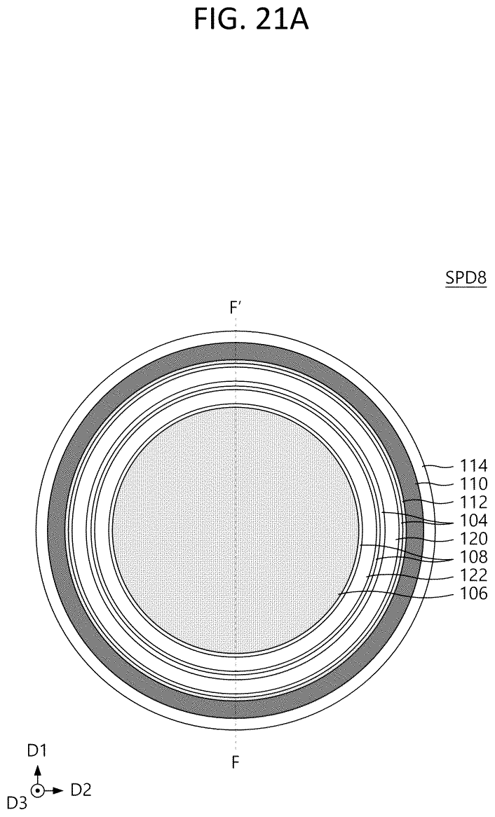

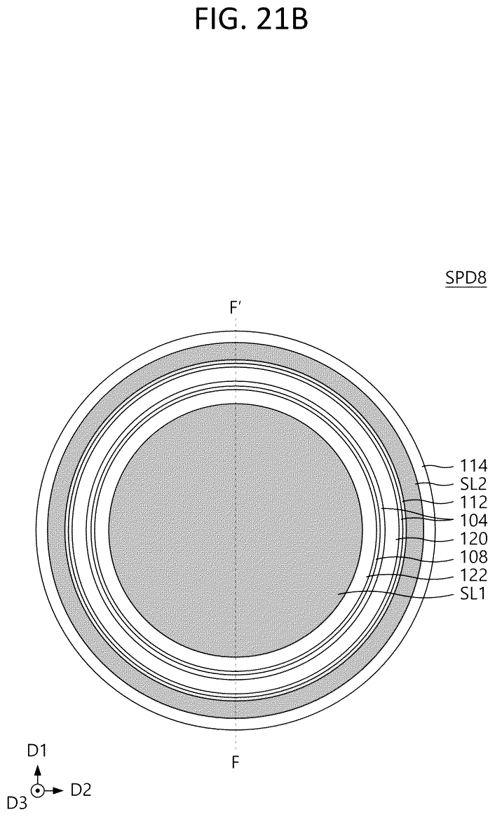

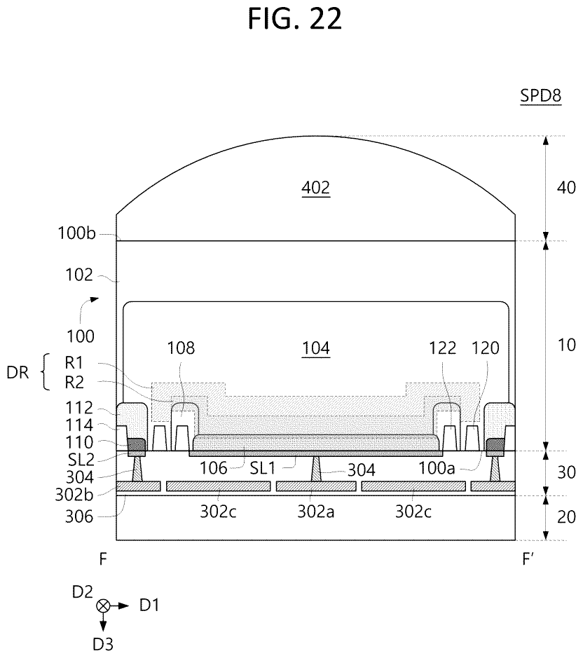

FIG. 21A is a plan view of a single photon detection device according to some example embodiments. FIG. 21B is a plan view for explaining the first silicide layer and the second silicide layer. FIG. 22 is a cross-sectional view along the F-F′ line of FIG. 21A. For brevity of explanation, differences from what is explained with reference to FIGS. 1 to 4 are explained.

Referring to FIGS. 21A to 22, a single photon detection device SPD8 may be provided. Unlike those illustrated in FIGS. 1 to 3, the single photon detection device SPD8 may include a first insulation pattern 120 and a second insulation pattern 122. The first insulation pattern 120 may be substantially the same as the first insulation pattern 120 explained with reference to FIGS. 17A to 18. The second insulation pattern 122 may be substantially the same as the second insulation pattern 122 explained with reference to FIGS. 19A and 20. Accordingly, the depletion region DR (or the first region R1 and the second region R2) may be formed widely, and as a result, the fill factor and efficiency may be improved. This disclosure can provide a single photon detection device SPD8 with improved fill factor and efficiency.

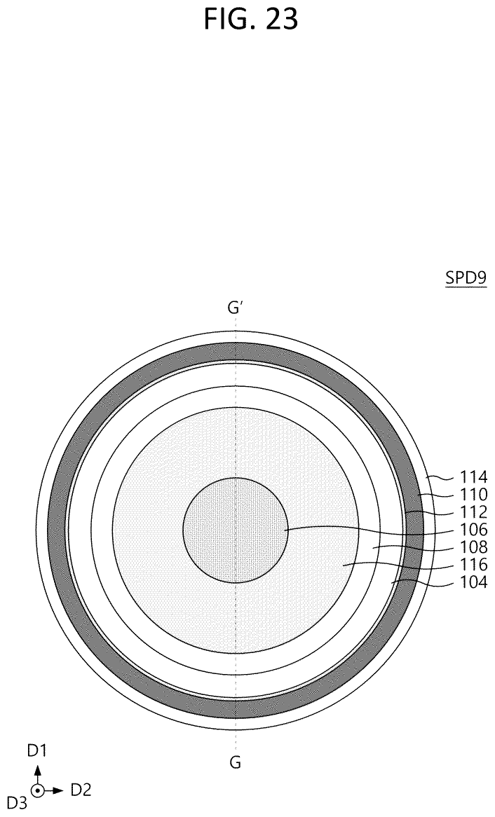

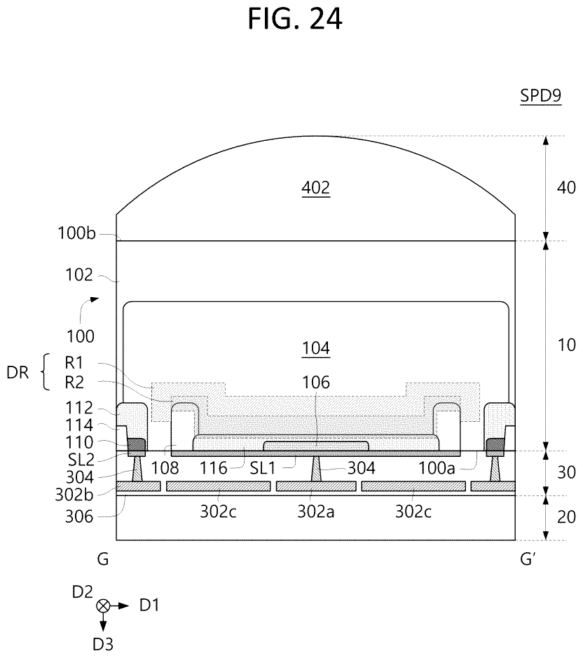

FIG. 23 is a plan view of a single photon detection device according to some example embodiments. FIG. 24 is a cross-sectional view along the G-G′ line of FIG. 23. For brevity of explanation, differences from what is explained with reference to FIGS. 1 to 4 are explained.

Referring to FIGS. 23 and 24, a single photon detection device SPD9 may be provided. Unlike those illustrated in FIGS. 1 to 3, the single photon detection device SPD9 may include a low-concentration doping region 116. The low-concentration doping region 116 may be provided between the high-concentration doping region 106 and the first well 104. The low-concentration doping region 116 may contact the top surface and side surface of the high-concentration doping region 106. The low-concentration doping region 116 may be exposed on the frontside surface 100a. On the frontside surface 100a, the low-concentration doping region 116 may surround the high-concentration doping region 106. The low-concentration doping region 116 may have the second conductivity type. The low-concentration doping region 116 may have a lower doping concentration than the high-concentration doping region 106. For example, the doping concentration of the low-concentration doping region 116 may be 1×10¹⁵ to 1×10¹⁹ cm⁻³. The low-concentration doping region 116 may be configured to form a depletion region DR in contact with the first well 104. The low-concentration doping region 116 may be configured to reduce or prevent tunneling effects that occur as the size of the semiconductor device becomes smaller. For example, the tunneling effect may be current flowing in the single photon avalanche diode 1050 even when no photon has entered. By using the low-concentration doping region 116 to form the depletion region DR, the tunneling noise and trap-assisted tunneling noise of the single photon avalanche diode 1050 may be reduced, and the operating wavelength range of the single photon detection device SPD9 may be broadened.

The first silicide layer SL1 may cover the bottom surfaces of the high-concentration doping region 106, the low-concentration doping region 116, and the guard ring 108. The first silicide layer SL1 may improve the electrical connection characteristics between the high-concentration doping region 106, the low-concentration doping region 116, and the vertical connections 304. For example, the first silicide layer SL1 may reduce the contact resistance between the high-concentration doping region 106 and the vertical connections 304. The first silicide layer SL1 may reduce or prevent voltage drop when voltage is applied to the high-concentration doping region 106 and the guard ring 108 through the first silicide layer SL1. The first silicide layer SL1 may be configured to ensure that voltage is uniformly applied to the high-concentration doping region 106 and the guard ring 108.

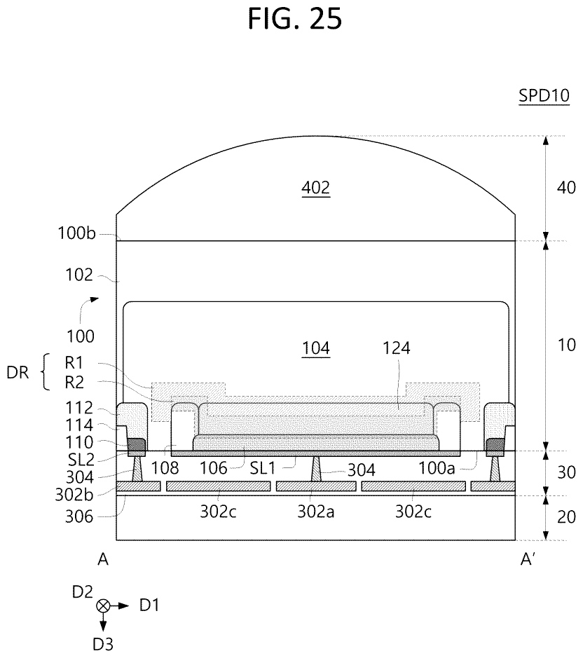

FIGS. 25 to 30 are cross-sectional views corresponding to the A-A′ line of FIG. 1. For brevity of explanation, differences from what is explained with reference to FIGS. 1 to 4 are explained.

Referring to FIG. 25, a single photon detection device SPD10 may be provided. Unlike those illustrated in FIGS. 1 to 3, the single photon detection device SPD10 may include a second well 124. The second well 124 may be provided between the first well 104 and the high-concentration doping region 106. The second well 124 may space the first well 104 and the high-concentration doping region 106 apart from each other. For example, the second well 124 may directly contact the first well 104 and the high-concentration doping region 106. The second well 124 may be provided in the inner region of the guard ring 108 having a ring shape. From the perspective looking at the frontside surface 100a, the second well 124 may be surrounded by the guard ring 108. For example, the second well 124 may directly contact the guard ring 108. In some example embodiments, the second well 124 and the guard ring 108 may be formed to substantially the same depth. The depth may refer to the distance from the frontside surface 100a. For example, the bottom surface of the second well 124 and the bottom surface of the guard ring 108 may be located at substantially the same depth. However, the depth of the second well 124 is not limited to being the same as the guard ring 108. In some example embodiments, the second well 124 may be formed to a depth deeper or shallower than the guard ring 108. The second well 124 may have the first conductivity type. For example, the doping concentration of the second well 124 may be 1×10¹⁵ to 5×10¹⁷ cm⁻³. In one example, the second well 124 may have a uniform doping concentration. In one example, the doping concentration of the second well 124 may decrease closer to the high-concentration doping region 106. However, the distribution of the doping concentration of the second well 124 may be determined as needed. For example, the doping concentration of the second well 124 may increase closer to the high-concentration doping region 106, or it may increase and then decrease as it gets closer to the high-concentration doping region 106. The second well 124 may strengthen the avalanche effect by increasing the electric field of the depletion region DR. The second well 124 may be configured to improve the characteristic of carriers (i.e., electrons or holes) moving from the first well 104 to the high-concentration doping region 106.

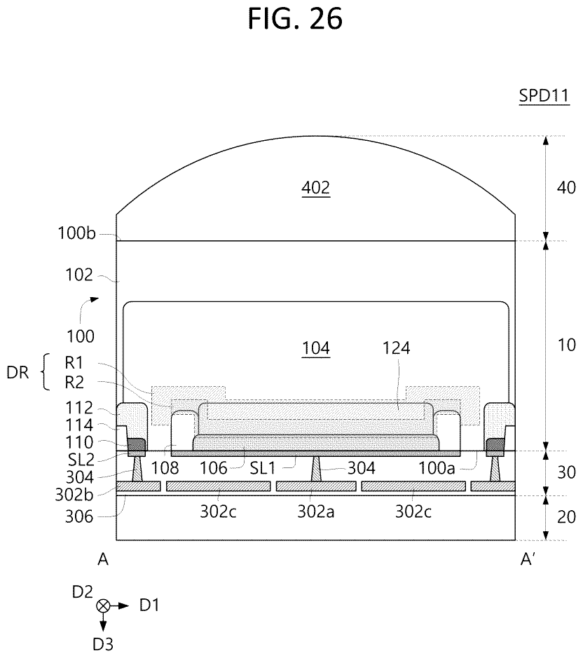

Referring to FIG. 26, a single photon detection device SPD11 may be provided. Unlike those illustrated in FIGS. 1 to 3, the guard ring 108 may extend from the frontside surface 100a to a depth shallower than the top surface of the second well 124. The top surface of the guard ring 108 may be located at a depth between the top surface of the second well 124 and the bottom surface of the second well 124.

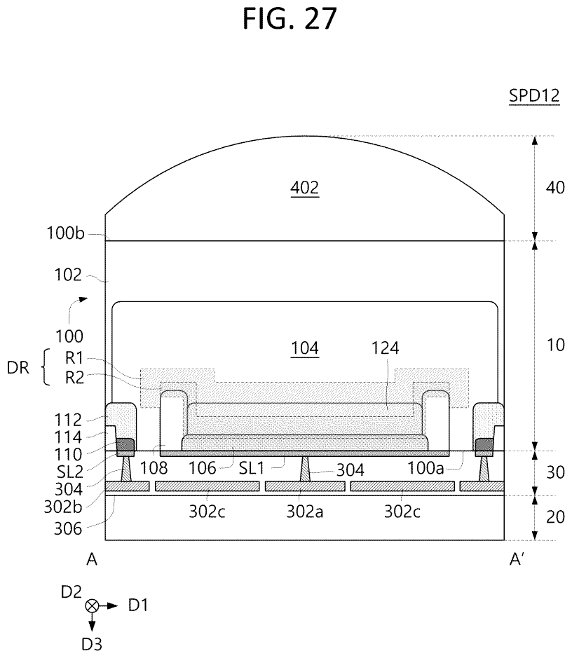

Referring to FIG. 27, a single photon detection device SPD12 may be provided. Unlike those illustrated in FIGS. 1 to 3, the guard ring 108 may extend from the frontside surface 100a to a depth deeper than the second well 124 and the relaxation region 112. The top surface of the guard ring 108 may be located at a depth between the top surface of the second well 124 and the top surface of the first well 104. The top surface of the guard ring 108 may be located at a depth between the top surface of the relaxation region 112 and the top surface of the first well 104.

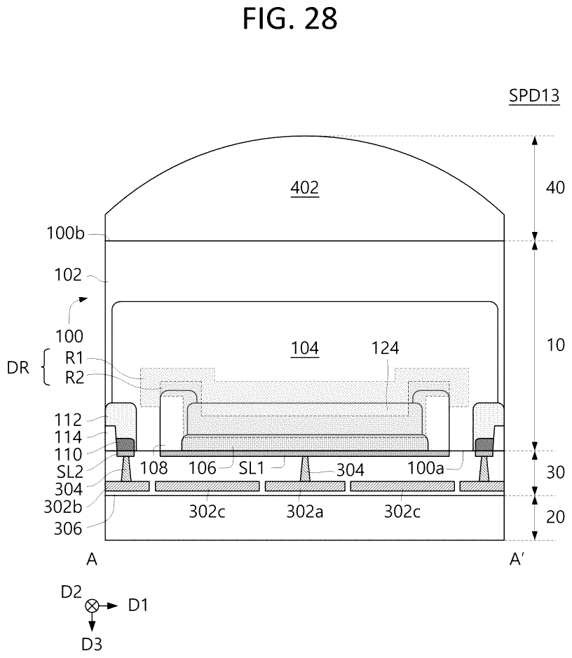

Referring to FIG. 28, a single photon detection device SPD13 may be provided. Unlike those illustrated in FIGS. 1 to 3, the guard ring 108 may extend from the frontside surface 100a to a depth deeper than the second well 124. The top surface of the guard ring 108 may be located at a depth between the top surface of the second well 124 and the top surface of the first well 104. The guard ring 108 may extend from the region on the side surface of the second well 124 to the region on the top surface of the second well 124. For example, the guard ring 108 may cover the edge portion of the top surface of the second well 124. The guard ring 108 may contact the top surface of the second well 124.

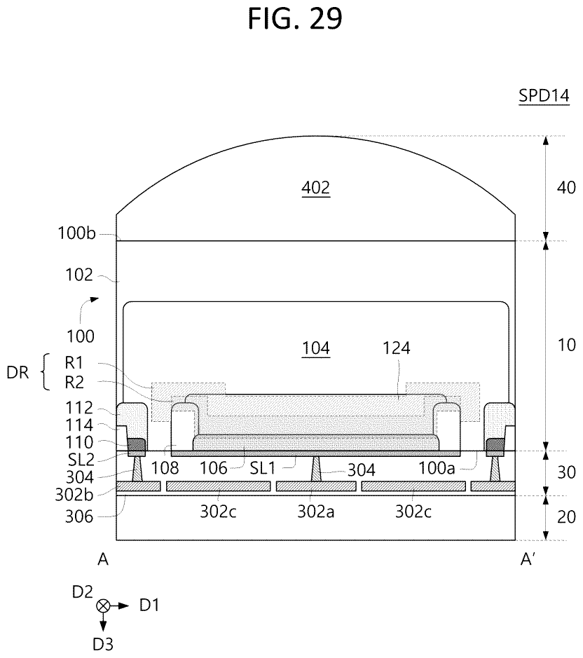

Referring to FIG. 29, a single photon detection device SPD14 may be provided. Unlike those illustrated in FIGS. 1 to 3, the second well 124 may extend from the frontside surface 100a to a depth deeper than the guard ring 108 and the relaxation region 112. The top surface of the second well 124 may be located at a depth between the top surface of the guard ring 108 and the top surface of the first well 104. The top surface of the second well 124 may be located at a depth between the top surface of the relaxation region 112 and the top surface of the first well 104. The second well 124 may extend from the region on the inner side surface of the guard ring 108 to the region on the top surface of the guard ring 108. For example, the second well 124 may cover the edge portion of the top surface of the guard ring 108. The second well 124 may contact the top surface of the guard ring 108.

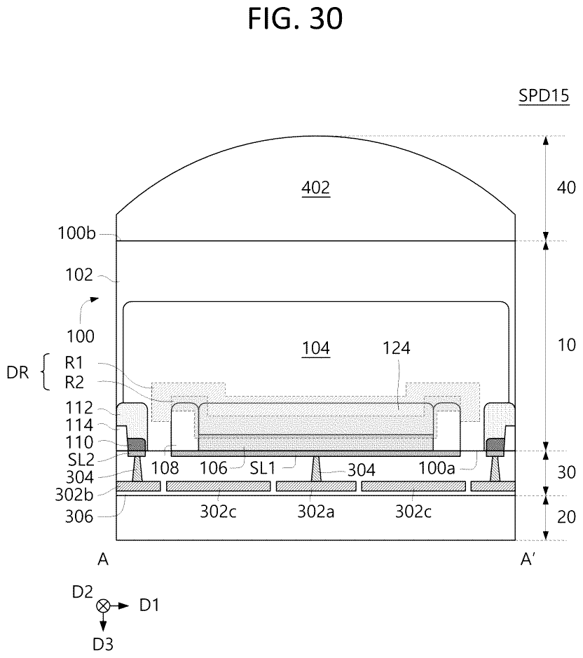

Referring to FIG. 30, a single photon detection device SPD15 may be provided. Unlike those illustrated in FIGS. 1 to 3, the high-concentration doping region 106 and the second well 124 may have substantially the same width. The side surface of the high-concentration doping region 106 may be aligned with the side surface of the second well 124. For example, the side surface of the high-concentration doping region 106 may be coplanar with the side surface of the second well 124.

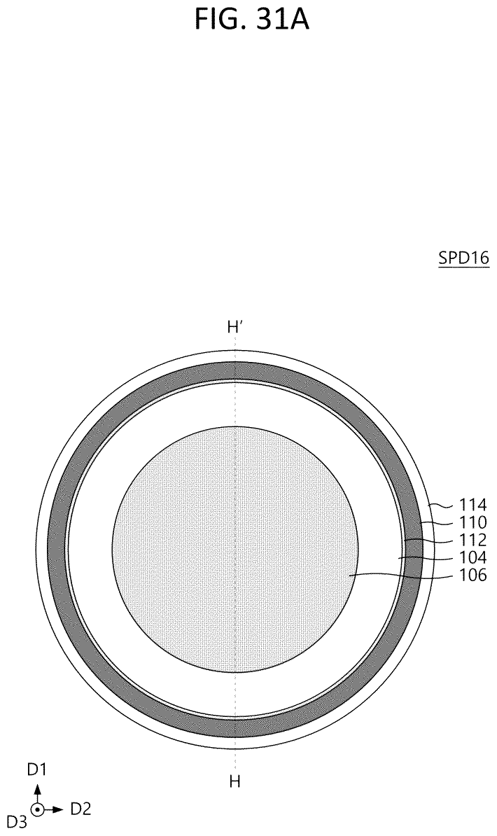

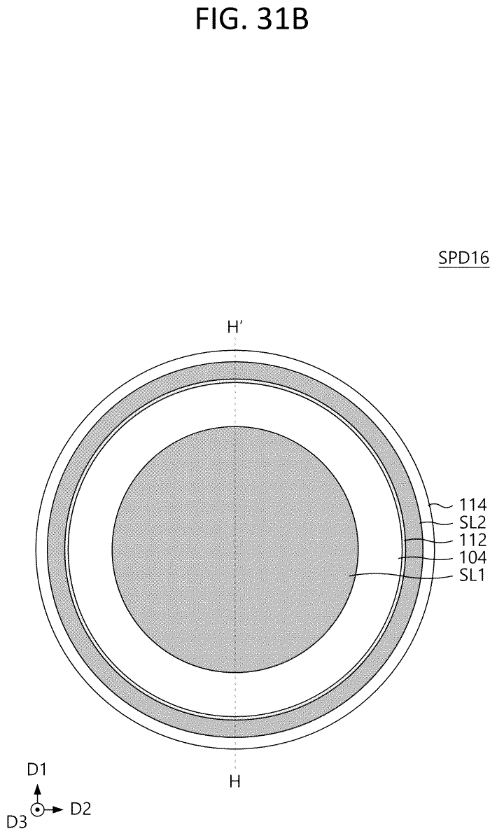

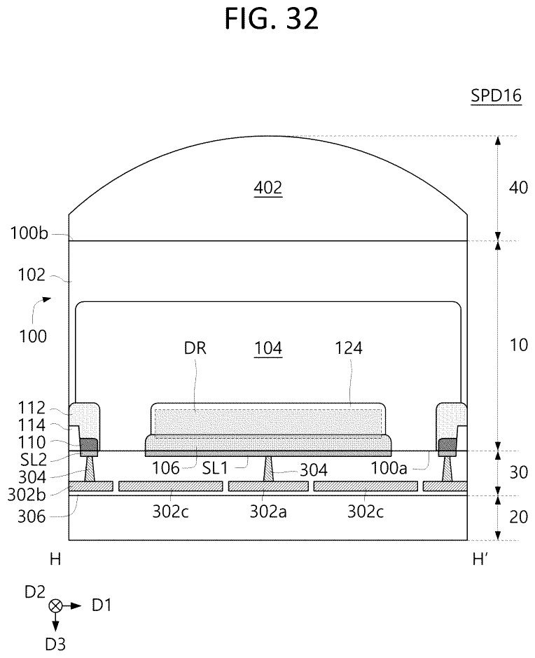

FIG. 31A is a plan view of a single photon detection device according to some example embodiments. FIG. 31B is a plan view for explaining the first silicide layer and the second silicide layer. FIG. 32 is a cross-sectional view along the H-H′ line of FIG. 31A. For brevity of explanation, differences from what is explained with reference to FIGS. 1 to 4 are explained.

Referring to FIGS. 31A to 32, a single photon detection device SPD16 may be provided. Unlike those illustrated in FIGS. 1 to 3, the single photon detection device SPD16 may not include a guard ring 108. The region between the high-concentration doping region 106 and the relaxation region 112 and the region between the second well 124 and the relaxation region 112 may be filled with the first well 104. The high-concentration doping region 106 may directly contact the first well 104.

A depletion region DR may be formed in a region adjacent to the interface between the second well 124 and the high-concentration doping region 106. The size of the depletion region DR is exemplarily illustrated and is not limiting. When a reverse bias is applied to the single photon detection device SPD16, a strong electric field may be formed in the depletion region DR. For example, when the single photon detection device SPD16 operates as a single photon avalanche diode (SPAD), the maximum intensity of the electric field may be about 1×10¹ to 1×10⁶ V/cm. Since electrons may be multiplied by the electric field of the depletion region DR, the depletion region DR may be referred to as a multiplication region.

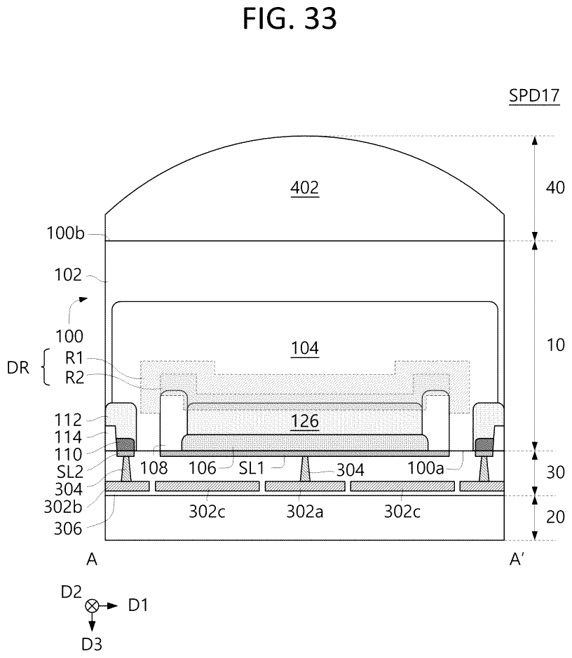

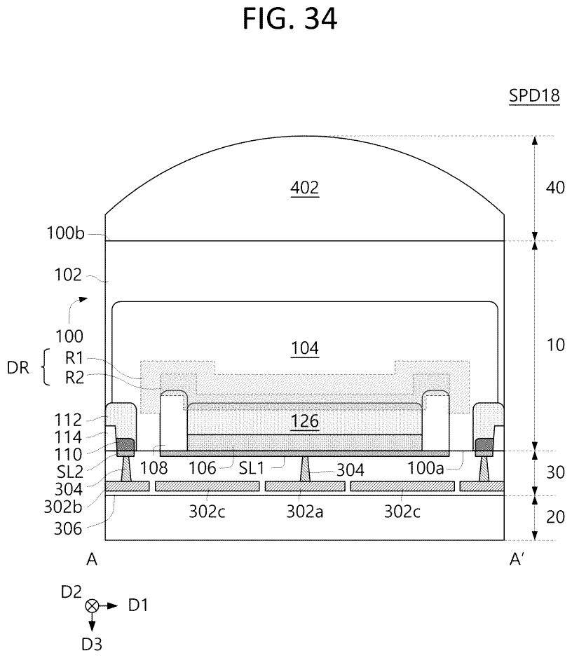

FIGS. 33 and 34 are cross-sectional views corresponding to the A-A′ line of FIG. 1. For brevity of explanation, differences from what is explained with reference to FIGS. 1 to 4 are explained.

Referring to FIG. 33, a single photon detection device SPD17 may be provided. Unlike those illustrated in FIGS. 1 to 3, the single photon detection device SPD17 may include a third well 126. The third well 126 may be provided between the first well 104 and the high-concentration doping region 106. The third well 126 may space the first well 104 and the high-concentration doping region 106 apart from each other. For example, the third well 126 may directly contact the first well 104 and the high-concentration doping region 106. The third well 126 may be provided in the inner region of the guard ring 108 having a ring shape. From the perspective looking at the frontside surface 100a, the third well 126 may be surrounded by the guard ring 108. For example, the third well 126 may directly contact the guard ring 108. In some example embodiments, the third well 126 may be formed to a depth shallower than the guard ring 108. The top surface of the third well 126 may be located closer to the frontside surface 100a than the top surface of the guard ring 108. The third well 126 may have the second conductivity type. The doping concentration of the third well 126 may be lower than the doping concentration of the high-concentration doping region 106 and higher than the doping concentration of the guard ring 108. For example, the doping concentration of the third well 126 may be 1×10¹⁵ to 5×10¹⁷ cm⁻³. The depletion region DR may be formed adjacent to the boundary between the third well 126 and the first well 104. The third well 126 may have a lower concentration than the high-concentration doping region 106. The depletion region DR may be formed widely due to the third well 126.

Referring to FIG. 34, a single photon detection device SPD18 may be provided. Unlike those illustrated in FIGS. 1 to 3, the high-concentration doping region 106 and the third well 126 may have substantially the same width. The side surface of the high-concentration doping region 106 may be aligned with the side surface of the third well 126. For example, the side surface of the high-concentration doping region 106 may be coplanar with the side surface of the third well 126.

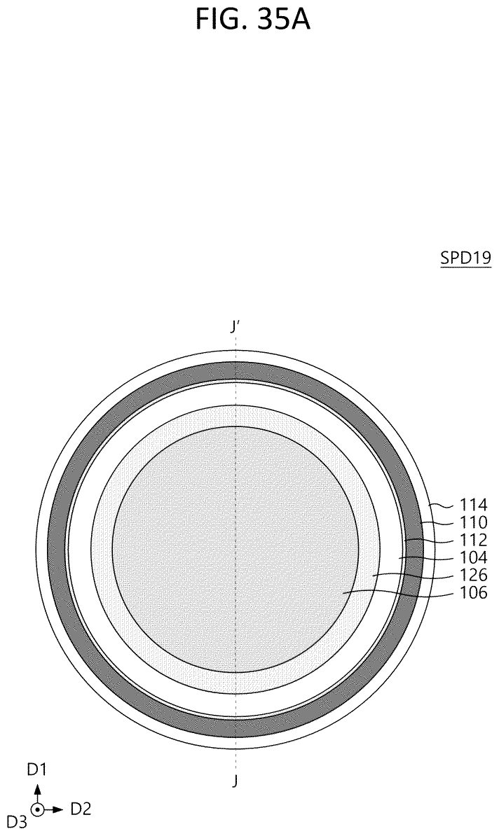

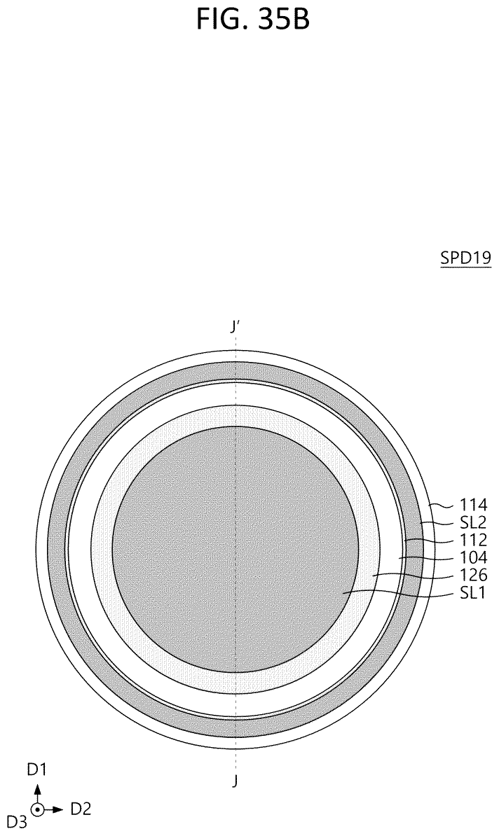

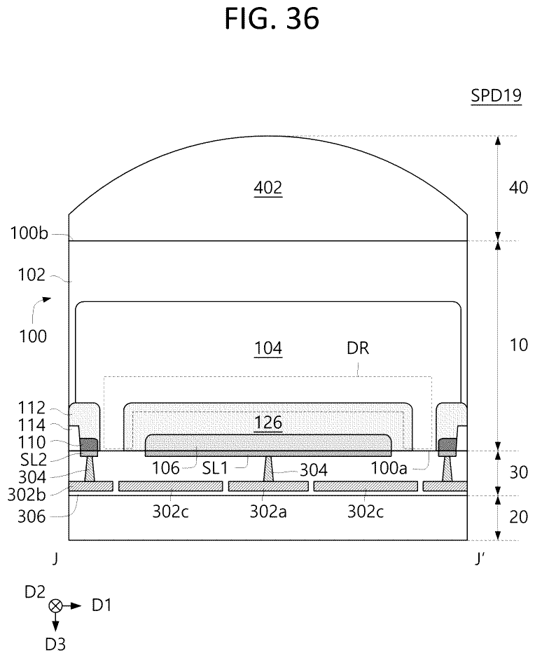

FIG. 35A is a plan view of a single photon detection device according to some example embodiments. FIG. 35B is a plan view for explaining the first silicide layer and the second silicide layer. FIG. 36 is a cross-sectional view along the J-J′ line of FIG. 35A. For brevity of explanation, differences from what is explained with reference to FIGS. 1 to 4 are explained.

Referring to FIGS. 35A to 36, a single photon detection device SPD19 may be provided. Unlike those illustrated in FIGS. 1 to 3, the single photon detection device SPD19 may not include a guard ring 108. A third well 118 may be provided between the first well 104 and the high-concentration doping region 106. The third well 118 may space the high-concentration doping region 106 and the first well 104 apart from each other. The third well 118 may have the second conductivity type. The doping concentration of the third well 118 may be lower than the doping concentration of the high-concentration doping region 106. For example, the doping concentration of the third well 118 may be 1×10¹⁶ to 1×10¹⁸ cm⁻³. The depletion region DR may be formed along the boundary between the third well 118 and the first well 104.

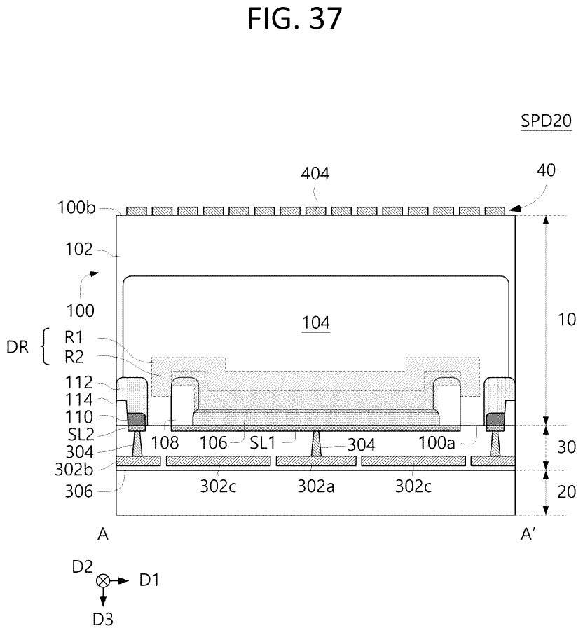

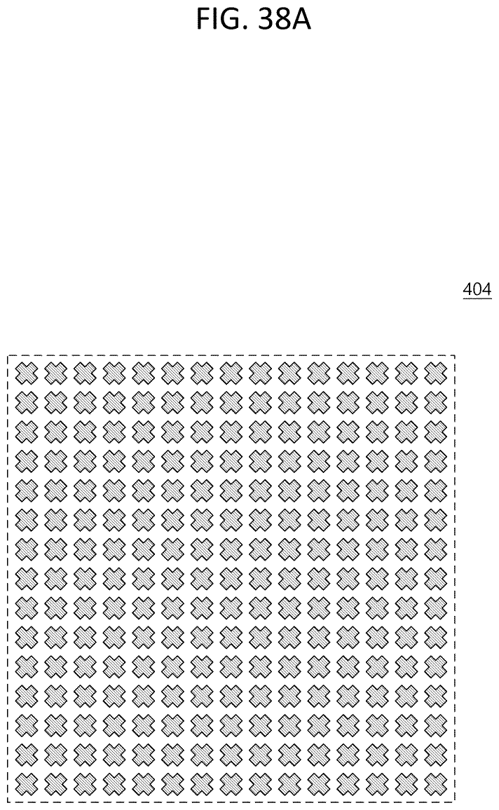

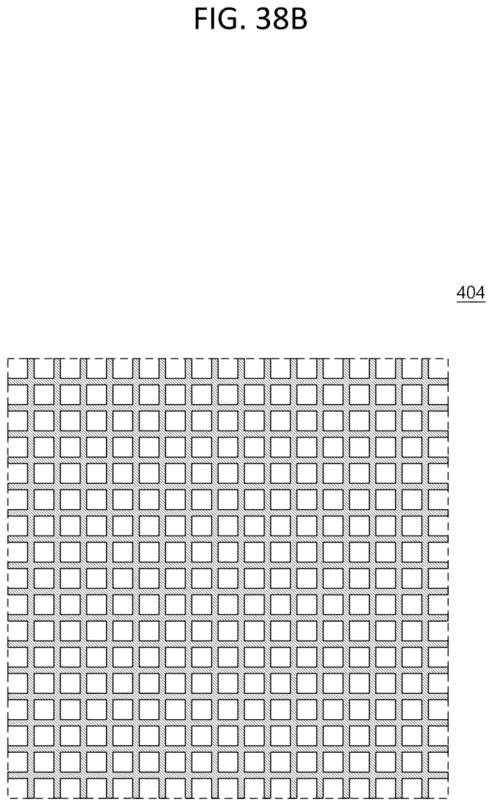

FIG. 37 is a cross-sectional view corresponding to the A-A′ line of FIG. 1. FIGS. 38A and 38B are plan views of the optical pattern layer according to some example embodiments of FIG. 37. For brevity of explanation, differences from what is explained with reference to FIGS. 1 to 4 are explained.

Referring to FIG. 37 and FIG. 38A, a single photon detection device SPD20 may be provided. Unlike those illustrated in FIGS. 1 to 3, the optical element layer 40 may include optical patterns 404 instead of the lens 402. In some example embodiments, the optical patterns 404 may be diffraction patterns. The diffraction patterns may be configured to diffract incident light. Light diffracted by the diffraction patterns may have a longer absorption length within the substrate 100 than non-diffracted light. In some example embodiments, the optical patterns 404 may be scattering patterns. The scattering patterns may be configured to scatter incident light. Light scattered by the scattering patterns may have a longer absorption length within the substrate 100 than non-scattered light. The optical pattern layer may increase the light absorption efficiency of the single photon detection device SPD20. The optical patterns 404 may be, for example, patterns in the shape of a plus (+) or an X. In some example embodiments, the optical patterns 404 may be patterns in a shape combining the plus (+) and X shapes or in a shape where each is connected. In some example embodiments, as illustrated in FIG. 38B, the optical patterns 404 may have a grid shape. In some example embodiments, at least one optical element may be inserted between the optical patterns 404 and the light detection layer 10. For example, the optical element may be a color filter, a bandpass filter, a metal grid, an air grid, a low refractive index material-based grid, an anti-reflection coating, a 2D nanomaterial layer, or an organic material layer.

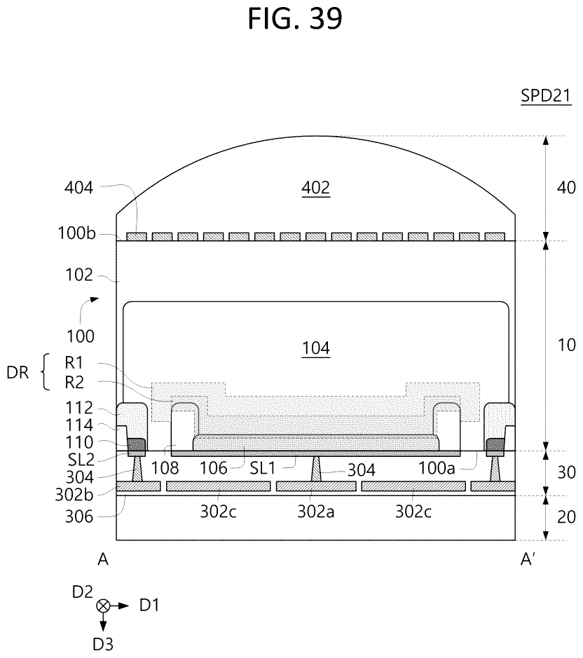

FIGS. 39 to 41 are cross-sectional views corresponding to the A-A′ line of FIG. 1. For brevity of explanation, differences from what is explained with reference to FIGS. 1 to 4 and FIGS. 37 to 38B are explained.

Referring to FIG. 39, a single photon detection device SPD21 may be provided. Unlike those illustrated in FIGS. 1 to 3, the single photon detection device SPD21 may include optical patterns 404. The optical patterns 404 may be substantially the same as the optical patterns 404 explained with reference to FIGS. 37 to 38B.

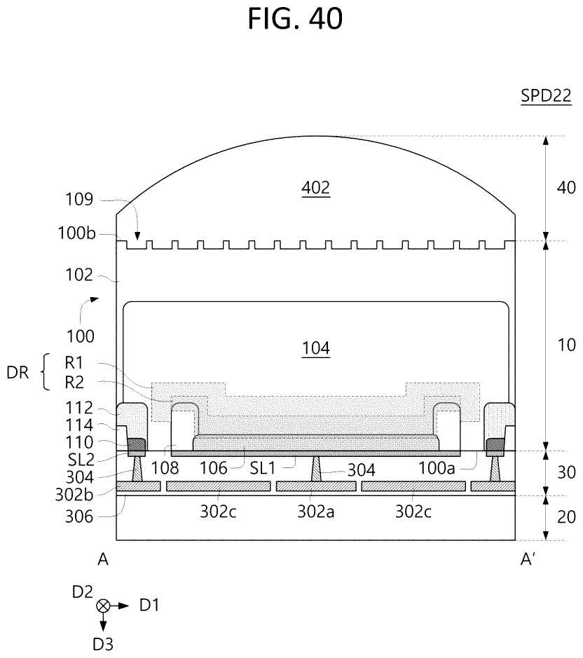

Referring to FIG. 40, a single photon detection device SPD22 may be provided. Unlike those illustrated in FIGS. 1 to 3, the single photon detection device SPD22 may include optical patterns 404.

Diffraction grooves 109 may be provided on the backside surface 100b of the substrate 100. For example, the diffraction grooves 109 may be formed by etching the backside surface 100b of the substrate 100. The diffraction grooves 109 may diffract incident light, increasing the absorption length of light within the substrate 100. In some example embodiments, scattering grooves may be formed on the backside surface 100b of the substrate 100 instead of the diffraction grooves 109. The scattering grooves may be formed by etching the backside surface 100b of the substrate 100. The scattering grooves may be, for example, grooves in the shape of a plus (+) or an X. In some example embodiments, the scattering grooves may be grooves in a shape combining the plus (+) and X shapes or in a shape where each is connected.

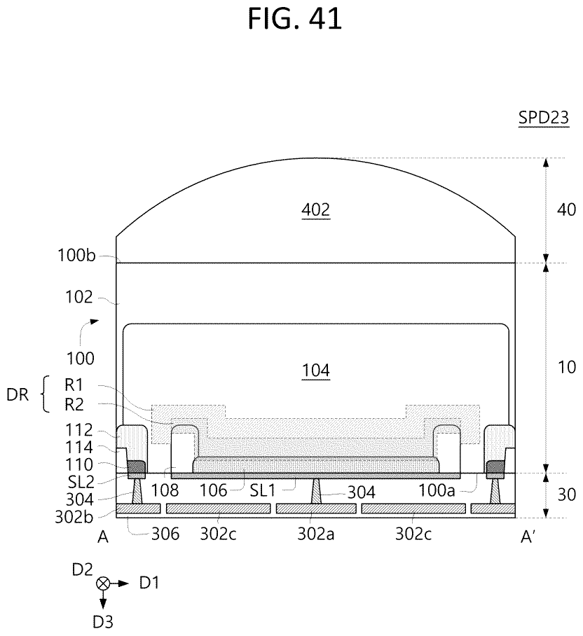

Referring to FIG. 41, a single photon detection device SPD23 may be provided. The single photon detection device SPD23 may include a light detection layer 10, a connection layer 30, and an optical element layer 40. Unlike those described with reference to FIGS. 1 to 4, the circuits necessary for the operation of the single photon detection device SPD23 may be formed in the light detection layer 10. For example, the circuits may be provided in a region adjacent to the frontside surface 100a of the substrate 100. For example, the circuits may be provided on the outside of the device isolation pattern 114, that is, on the opposite side of the contact region 110 with respect to the device isolation pattern 114. The circuits may be implemented by various electronic devices as needed. The circuits may include quenching resistors (or quenching circuits) and pixel circuits. The quenching resistor (or quenching circuit) may be configured to stop the avalanche effect and allow the single photon detection device SPD23 to detect another photon. The pixel circuit may consist of reset or recharge circuits, memory, amplification circuits, counters, gate circuits, time-to-digital converters, etc. Also, the circuits may include DC-DC converters and other power management integrated circuits. The circuits may transmit signals to the light detection layer 10 or receive signals from the light detection layer 10.

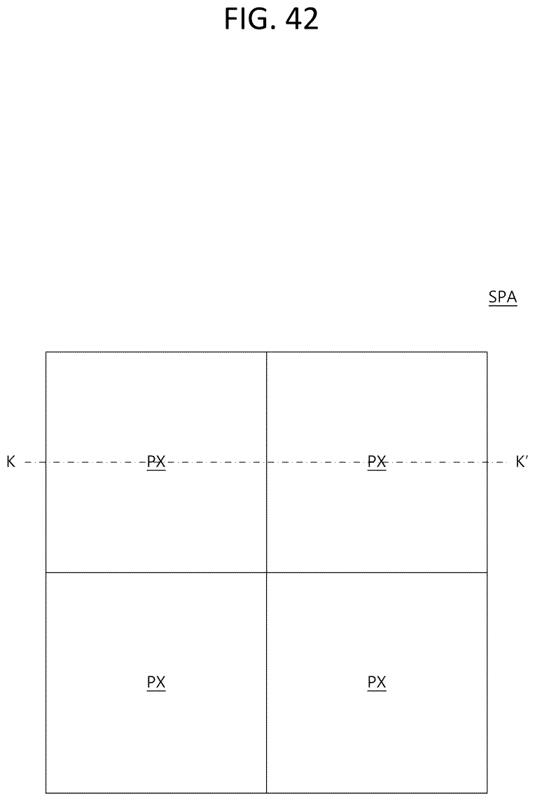

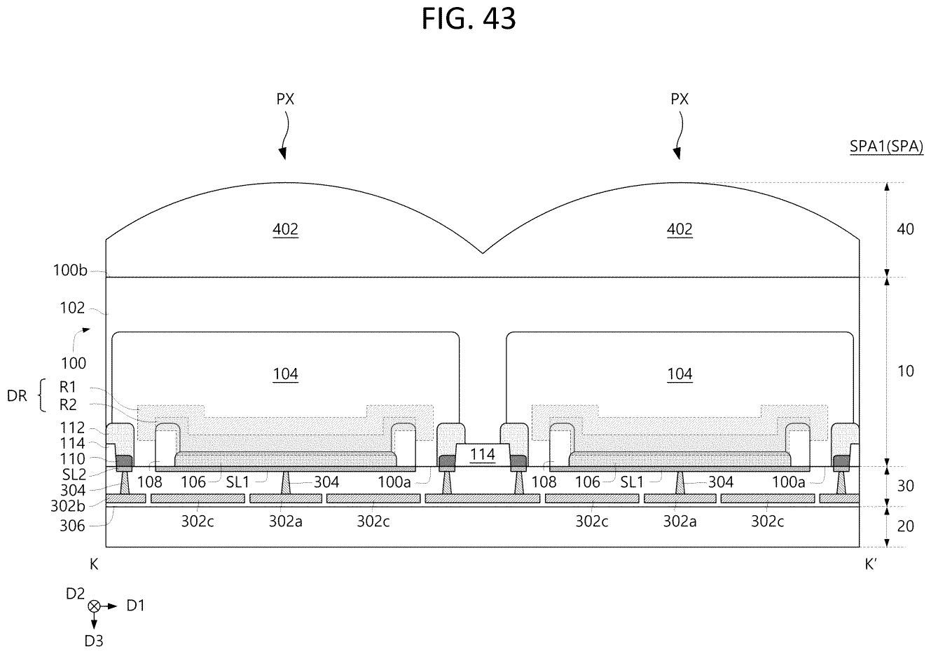

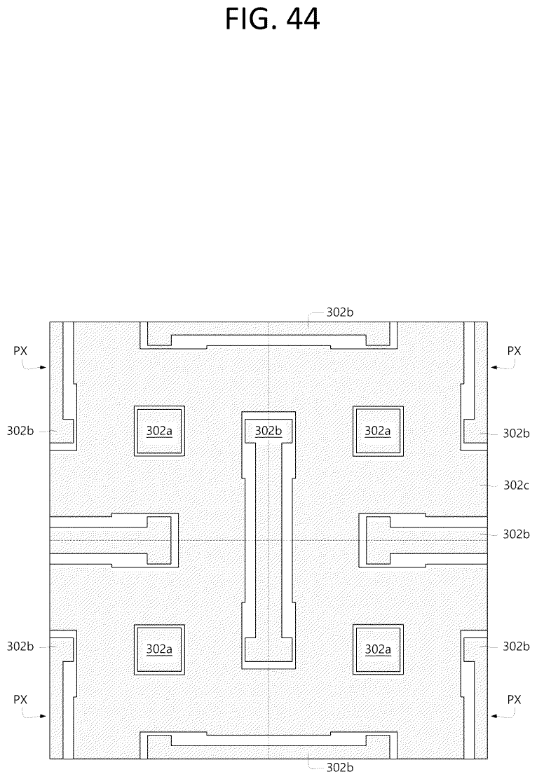

FIG. 42 is a plan view of a single photon detection device array according to some example embodiments. FIG. 43 is a cross-sectional view along the K-K′ line of FIG. 42. FIG. 44 is a plan view of the output pattern, bias pattern, and shield pattern of FIG. 43. For brevity of explanation, content that is substantially the same as what is explained with reference to FIGS. 1 to 4 may not be explained.

Referring to FIGS. 42 to 44, a single photon detection device array SPA1(SPA) may be provided. The single photon detection device array SPA1(SPA) may include pixels PX arranged in two dimensions. Each of the pixels PX may include the single photon detection device SPD1 explained with reference to FIGS. 1 to 4. The light detection layers 10 of the single photon detection devices SPD1 may be connected to form the light detection layer 10 of the single photon detection device array SPA1(SPA). The connection layers 30 of the single photon detection devices SPD1 may be connected to form the connection layer 30 of the single photon detection device array SPA1(SPA). The control layers 20 of the single photon detection devices SPD1 may be connected to form the control layer 20 of the single photon detection device array SPA1(SPA). The optical element layers 40 of the single photon detection devices SPD1 may be connected to form the optical element layer 40 of the single photon detection device array SPA1(SPA). In some example embodiments, at least one optical element may be inserted between the lens 402 and the light detection layer 10. For example, the optical element may be a color filter, a bandpass filter, a metal grid, an air grid, a low refractive index material-based grid, an anti-reflection coating, a 2D nanomaterial layer, or an organic material layer. In one example, the anti-reflection coating may be formed on top of the lens 402.

The first silicide layer SL1 and the second silicide layer SL2 may be reflection layers. Light that is not absorbed in the substrate 100 and passes through the light detection layer 10 may be reflected by the first silicide layer SL1 and the second silicide layer SL2, and may re-enter the light detection layer 10. Accordingly, the light absorption efficiency of the single photon detection device array SPA1(SPA) can be improved.

A pair of contact regions 110, each included in different pixels PX and directly adjacent to each other, may be configured to share one bias pattern 302b. For example, one bias pattern 302b and a pair of contact regions 110 may be electrically connected by a pair of vertical connections 304, respectively. A device isolation pattern 114 may be arranged between directly adjacent pixels PX. For example, the device isolation pattern 114 may be STI (shallow trench isolation). For example, the vertical connection 304 may include a contact or a via.

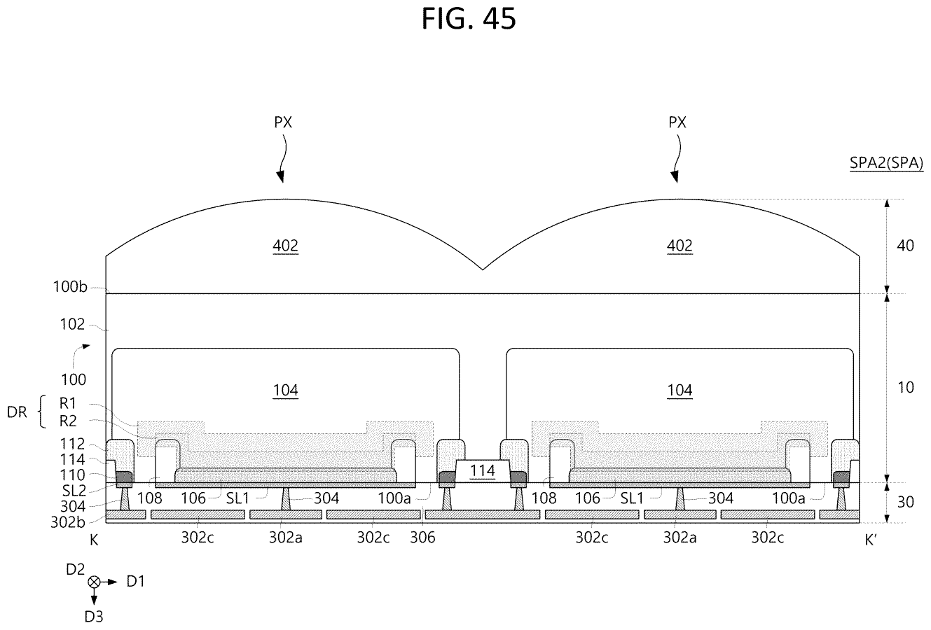

FIGS. 45 to 52 are cross-sectional views along the K-K′ line of FIG. 42. For brevity of explanation, content that is substantially the same as what is explained with reference to FIGS. 42 to 44 may not be explained.

Referring to FIG. 42 and FIG. 45, a single photon detection device array SPA2(SPA) may be provided. The single photon detection device array SPA2(SPA) may include pixels PX arranged in two dimensions. Each of the pixels PX may include the single photon detection device SPD23 explained with reference to FIG. 41. The light detection layers 10 of the single photon detection devices SPD23 may be connected to form the light detection layer 10 of the single photon detection device array SPA2(SPA). The connection layers 30 of the single photon detection devices SPD23 may be connected to form the connection layer 30 of the single photon detection device array SPA2(SPA). The optical element layers 40 of the single photon detection devices SPD23 may be connected to form the optical element layer 40 of the single photon detection device array SPA2(SPA). The light detection layer 10, connection layer 30, and optical element layer 40 may be substantially the same as the light detection layer 10, connection layer 30, and optical element layer 40 explained with reference to FIGS. 42 to 44, respectively.

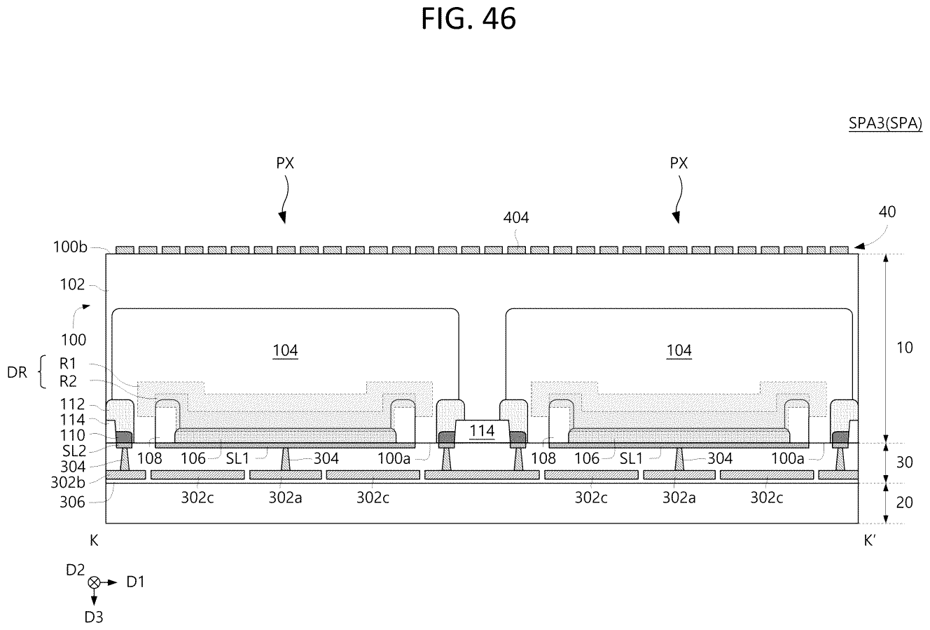

Referring to FIG. 42 and FIG. 46, a single photon detection device array SPA3(SPA) may be provided. The single photon detection device array SPA3(SPA) may include pixels PX arranged in two dimensions. Each of the pixels PX may include the single photon detection device SPD20 explained with reference to FIG. 37. The light detection layers 10 of the single photon detection devices SPD20 may be connected to form the light detection layer 10 of the single photon detection device array SPA3(SPA). The connection layers 30 of the single photon detection devices SPD20 may be connected to form the connection layer 30 of the single photon detection device array SPA3(SPA). The control layers 20 of the single photon detection devices SPD20 may be connected to form the control layer 20 of the single photon detection device array SPA3(SPA). The optical element layers 40 of the single photon detection devices SPD20 may be connected to form the optical element layer 40 of the single photon detection device array SPA3(SPA).

The optical element layer 40 may include diffraction patterns 404. The diffraction patterns 404 may diffract incident light, increasing the absorption length of light within the light detection layer 10. In some example embodiments, scattering patterns may be provided on the backside surface 100b of the substrate 100 instead of the diffraction patterns 404. The scattering patterns may be, for example, patterns in the shape of a plus (+) or an X. In some example embodiments, the scattering patterns may be patterns in a shape combining the plus (+) and X shapes or in a shape where each is connected. The optical element layer 40 may improve the light absorption efficiency of the single photon detection device array SPA3(SPA). In one embodiment, at least one optical element may be inserted between the diffraction patterns 404 and the light detection layer 10. For example, the optical element may be a color filter, a bandpass filter, a metal grid, an air grid, a low refractive index material-based grid, an anti-reflection coating, a 2D nanomaterial layer, or an organic material layer.

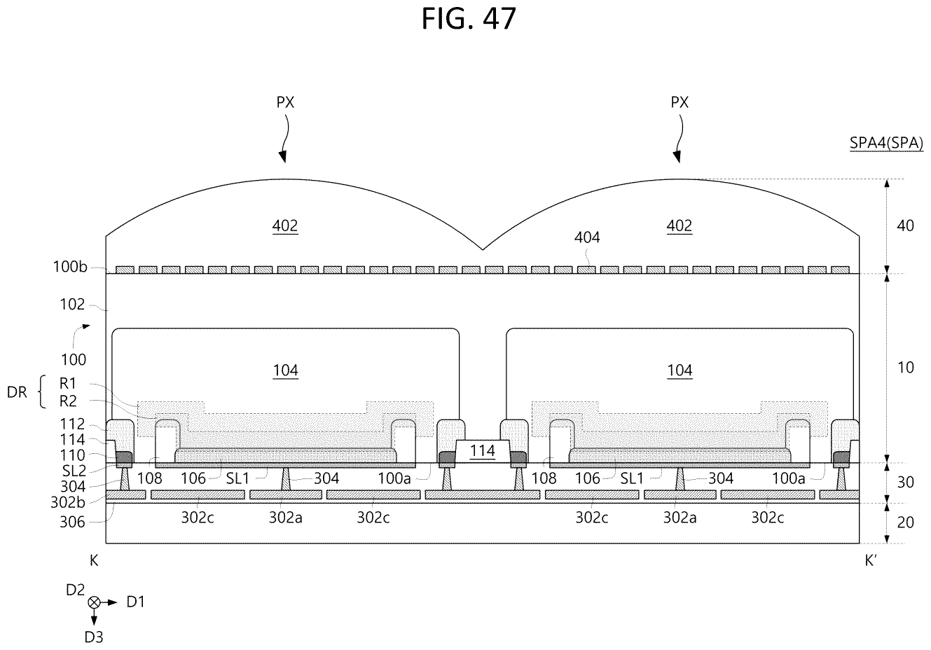

Referring to FIG. 42 and FIG. 47, a single photon detection device array SPA4(SPA) may be provided. The single photon detection device array SPA4(SPA) may include pixels PX arranged in two dimensions. Each of the pixels PX may include the single photon detection device SPD21 explained with reference to FIG. 39. The light detection layers 10 of the single photon detection devices SPD21 may be connected to form the light detection layer 10 of the single photon detection device array SPA4(SPA). The connection layers 30 of the single photon detection devices SPD21 may be connected to form the connection layer 30 of the single photon detection device array SPA4(SPA). The control layers 20 of the single photon detection devices SPD21 may be connected to form the control layer 20 of the single photon detection device array SPA4(SPA). The optical element layers 40 of the single photon detection devices SPD21 may be connected to form the optical element layer 40 of the single photon detection device array SPA4(SPA).

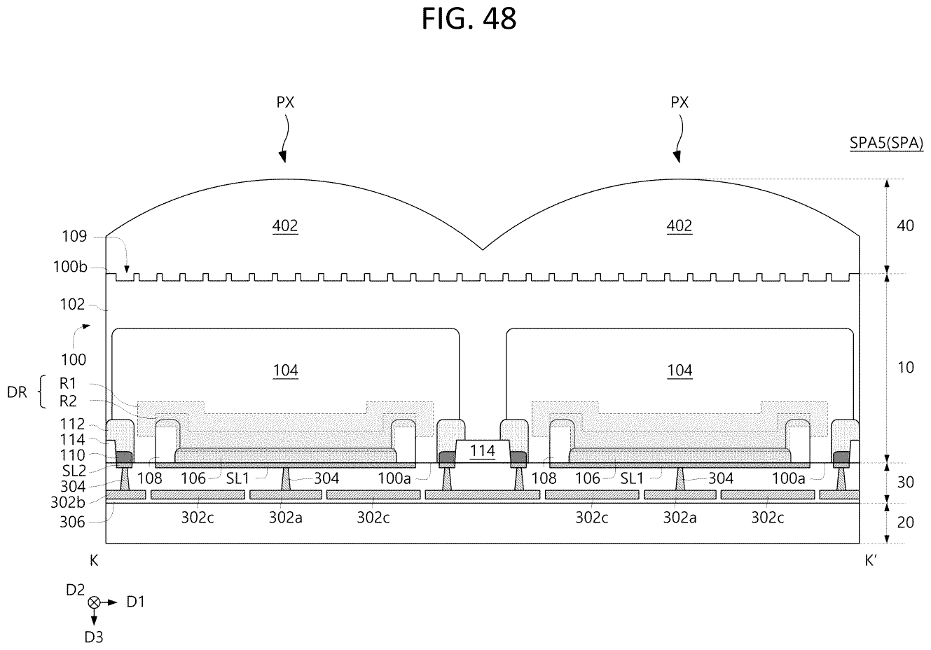

Referring to FIG. 42 and FIG. 48, a single photon detection device array SPA5(SPA) may be provided. The single photon detection device array SPA5(SPA) may include pixels PX arranged in two dimensions. Each of the pixels PX may include the single photon detection device SPD22 explained with reference to FIG. 40. The light detection layers 10 of the single photon detection devices SPD22 may be connected to form the light detection layer 10 of the single photon detection device array SPA5(SPA). The connection layers 30 of the single photon detection devices SPD22 may be connected to form the connection layer 30 of the single photon detection device array SPA5(SPA). The control layers 20 of the single photon detection devices SPD22 may be connected to form the control layer 20 of the single photon detection device array SPA5(SPA). The optical element layers 40 of the single photon detection devices SPD22 may be connected to form the optical element layer 40 of the single photon detection device array SPA5(SPA).

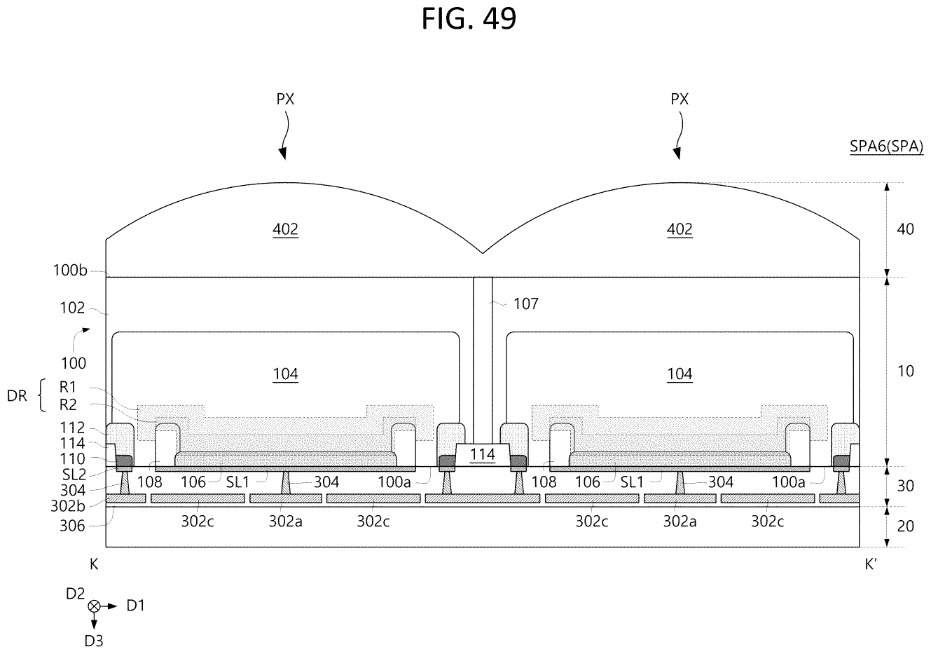

Referring to FIG. 42 and FIG. 49, a single photon detection device array SPA6(SPA) may be provided. The single photon detection device array SPA6(SPA) may include pixels PX arranged in two dimensions. A device isolation pattern 114 may be arranged between directly adjacent pixels PX. For example, the device isolation pattern 114 may be STI. Unlike those illustrated in FIGS. 42 to 44, a vertical isolation pattern 107 may be provided between the device isolation pattern 114 and the backside surface 100b. For example, the vertical isolation pattern 107 may be FTI (full trench isolation). One end of the vertical isolation pattern 107 may directly contact the device isolation pattern 114, and the other end may be exposed on the backside surface 100b. For example, the top surface of the vertical isolation pattern 107 may be located at substantially the same level as the backside surface 100b. The vertical isolation pattern 107 may be formed by a process of filling a material that prevents crosstalk between adjacent pixels PX into a recess region formed by etching the substrate region 102. For example, the vertical isolation pattern 107 may include metal (e.g., copper (Cu), aluminum (Al), tungsten (W), titanium (Ti)), polysilicon, high-k material (e.g., hafnium oxide (HfO₂), zirconium oxide (zirconia, ZrO₂), tantalum oxide (TaO)), or a combination thereof.

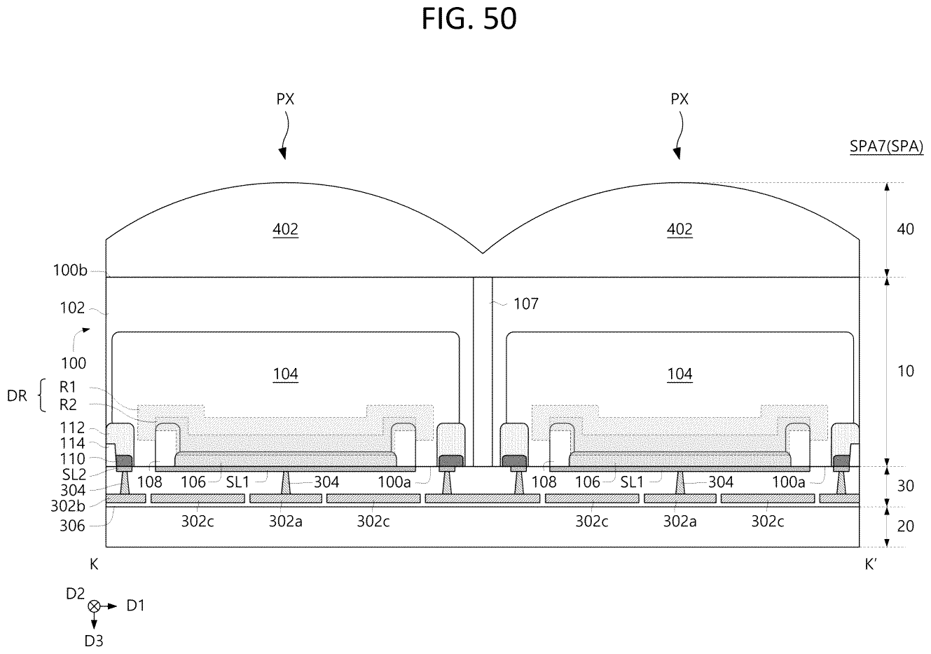

Referring to FIG. 42 and FIG. 50, a single photon detection device array SPA7(SPA) may be provided. The single photon detection device array SPA7(SPA) may include pixels PX arranged in two dimensions. Unlike those illustrated in FIGS. 42 to 44, the single photon detection device array SPA7(SPA) may include a vertical isolation pattern 107 that completely penetrates the substrate 100 without a device isolation pattern 114. For example, the vertical isolation pattern 107 may be FTI (full trench isolation). One end of the vertical isolation pattern 107 may be exposed on the frontside surface 100a, and the other end may be exposed on the backside surface 100b. For example, the bottom surface and top surface of the vertical isolation pattern 107 may be located at substantially the same level as the frontside surface 100a and the backside surface 100b, respectively. For example, the vertical isolation pattern 107 may be formed by a process of forming a hole extending from the frontside surface 100a to the backside surface 100b in the substrate 100, and then filling the hole with a material that prevents crosstalk between adjacent pixels PX. For example, the vertical isolation pattern 107 may include metal (e.g., copper (Cu), aluminum (Al), tungsten (W), titanium (Ti)), polysilicon, high-k material (e.g., hafnium oxide (HfO₂), zirconium oxide (zirconia, ZrO₂), tantalum oxide (TaO)), or a combination thereof.

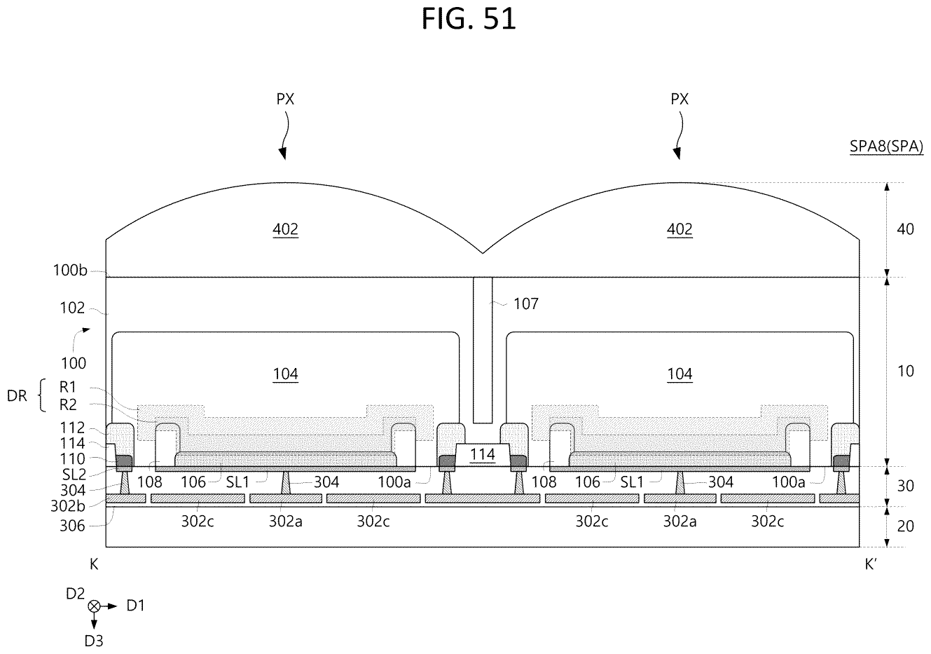

Referring to FIG. 42 and FIG. 51, a single photon detection device array SPA8(SPA) may be provided. The single photon detection device array SPA8(SPA) may include pixels PX arranged in two dimensions. A device isolation pattern 114 may be arranged between directly adjacent pixels PX. For example, the device isolation pattern 114 may be STI. Unlike those illustrated in FIGS. 42 to 44, a vertical isolation pattern 107 may be provided between the device isolation pattern 114 and the backside surface 100b. The device isolation pattern 114 and the vertical isolation pattern 107 may be spaced apart from each other. For example, the vertical isolation pattern 107 may be DTI or Partial DTI. One end of the vertical isolation pattern 107 may be arranged adjacent to the device isolation pattern 114, and the other end may be exposed on the backside surface 100b. A substrate region 102 may be provided between the vertical isolation pattern 107 and the device isolation pattern 114. For example, the top surface of the vertical isolation pattern 107 may be located at substantially the same level as the backside surface 100b. The vertical isolation pattern 107 may be formed by a process of filling a material that prevents crosstalk between adjacent pixels PX into a recess region formed by etching the substrate region 102. For example, the vertical isolation pattern 107 may include metal (e.g., copper (Cu), aluminum (Al), tungsten (W), titanium (Ti)), polysilicon, high-k material (e.g., hafnium oxide (HfO₂), zirconium oxide (zirconia, ZrO2), tantalum oxide (TaO)), or a combination thereof.

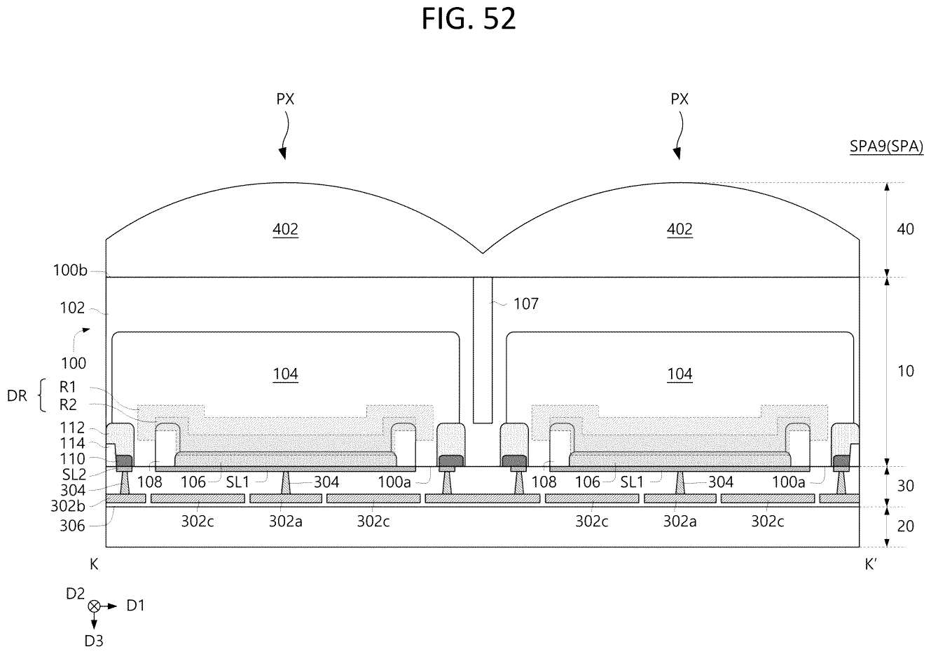

Referring to FIG. 42 and FIG. 52, a single photon detection device array SPA9(SPA) may be provided. The single photon detection device array SPA9(SPA) may include pixels PX arranged in two dimensions. Unlike those illustrated in FIGS. 42 to 44, the single photon detection device array SPA9(SPA) may include a vertical isolation pattern 107 that partially penetrates the substrate 100 without a device isolation pattern 114. One end of the vertical isolation pattern 107 may be arranged adjacent to the frontside surface 100a of the substrate 100, and the other end may be exposed on the backside surface 100b. For example, the top surface of the vertical isolation pattern 107 may be located at substantially the same level as the backside surface 100b. The vertical isolation pattern 107 may be formed by a process of filling a material that prevents crosstalk between adjacent pixels PX into a recess region formed by etching the substrate region 102. For example, the vertical isolation pattern 107 may include metal (e.g., copper (Cu), aluminum (Al), tungsten (W), titanium (Ti)), polysilicon, high-k material (e.g., hafnium oxide (HfO₂), zirconium oxide (zirconia, ZrO2), tantalum oxide (TaO)), or a combination thereof.

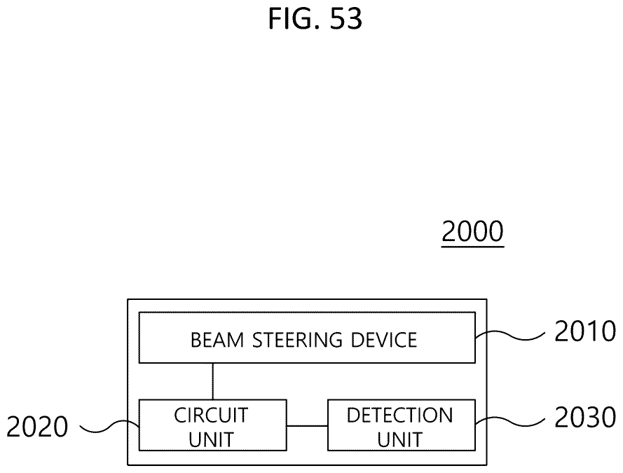

FIG. 53 is a block diagram for explaining an electronic device according to some example embodiments.

Referring to FIG. 53, an electronic device 2000 may be provided. The electronic device 2000 may emit light towards a subject (not illustrated) and sense light reflected by the subject and returning to the electronic device 2000. The electronic device 2000 may include a beam steering device 2010. The beam steering device 2010 may adjust the direction of light emitted from the electronic device 2000. The beam steering device 2010 may be a mechanical or non-mechanical (semiconductor) beam steering device. The electronic device 2000 may include a light source unit within the beam steering device 2010, or may include a light source unit provided separately from the beam steering device 2010. The beam steering device 2010 may be a scanning-type light emission device. However, the light emission device of the electronic device 2000 is not limited to the beam steering device 2010. In some example embodiments, the electronic device 2000 may include a flash-type light emission device instead of or along with the beam steering device 2010. The flash-type light emission device may emit light to a region covering the entire field of view at once without a scanning process.

Light steered by the beam steering device 2010 may be reflected by the subject and return to the electronic device 2000. The electronic device 2000 may include a detection unit 2030 for detecting light reflected by the subject. The detection unit 2030 may include multiple light detection elements and may further include other optical components. The multiple light detection elements may include any one of the single photon detection devices SPD1 to SPD23 described above. In addition, the electronic device 2000 may further include a circuit unit 2020 connected to at least one of the beam steering device 2010 and the detection unit 2030. The circuit unit 2020 may include a computation unit that acquires and processes data, and may further include a driving unit and a control unit. Also, the circuit unit 2020 may further include a power unit and memory.

Although it is illustrated that the electronic device 2000 includes the beam steering device 2010 and the detection unit 2030 within a single device, the beam steering device 2010 and the detection unit 2030 may not be provided in a single device, but may be provided in separate devices. Additionally, the circuit unit 2020 may not be connected to the beam steering device 2010 or the detection unit 2030 by wire, but may be connected by wireless communication.

The electronic device 2000 according to some example embodiments described above can be applied to various electronic devices. For example, the electronic device 2000 can be applied to a LiDAR (Light Detection And Ranging) device. The LiDAR device may be a phase-shift type or TOF (time-of-flight) type device. Furthermore, the single photon detection devices SPD1 to SPD23 according to some example embodiments or the electronic device 2000 including them may be mounted on electronic devices such as smartphones, wearable devices (e.g., augmented reality and virtual reality implementation glasses-type devices), Internet of Things (IoT) devices, home appliances, tablet PCs, PDAs (Personal Digital Assistants), PMPs (Portable Multimedia Players), navigation devices, drones, robots, unmanned vehicles, autonomous vehicles, Advanced Driver Assistance Systems (ADAS), and the like.

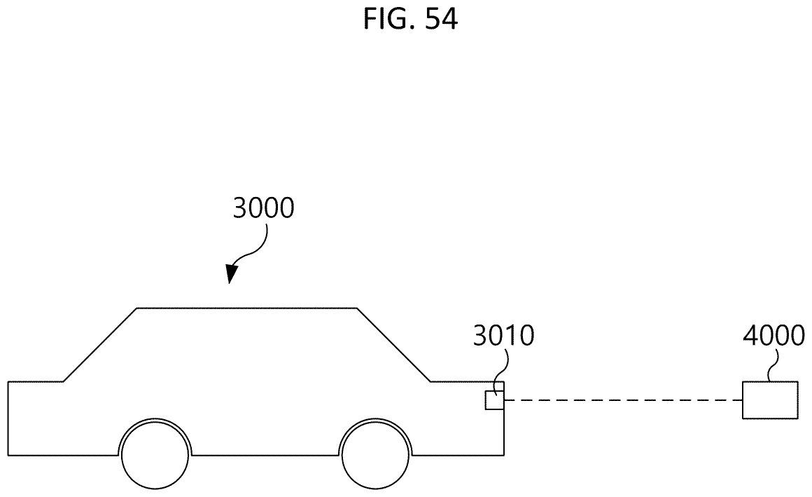

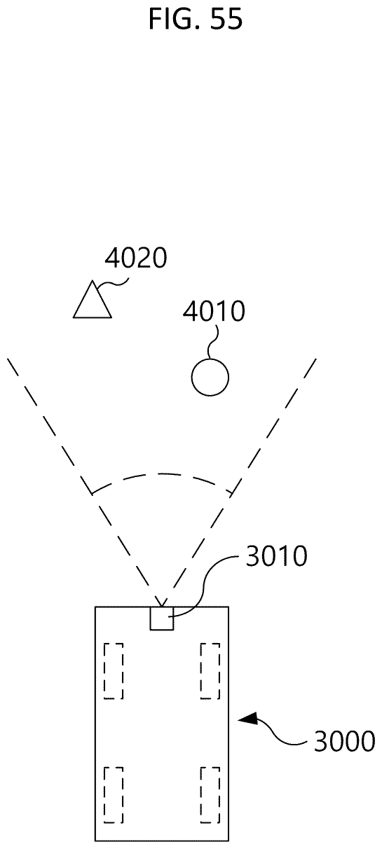

FIGS. 54 and 55 are conceptual diagrams illustrating the application of a LiDAR device to a vehicle according to some example embodiments.

Referring to FIGS. 54 and 55, a LiDAR device 3010 may be applied to a vehicle 3000. Information about a subject 4000 can be acquired using the LiDAR device 3010 applied to the vehicle. The vehicle 3000 may be an automobile with autonomous driving capabilities. The LiDAR device 3010 can detect objects or people, i.e., subjects 4000, in the direction the vehicle 3000 is traveling. The LiDAR device 3010 can measure the distance to the subject 4000 using information such as the time difference between the transmitted signal and the detected signal. The LiDAR device 3010 can acquire information about nearby subjects 4010 and distant subjects 4020 within the scanning range. The LiDAR device 3010 may include the electronic device 2000 described with reference to FIG. 53. Although it is illustrated that the LiDAR device 3010 is placed at the front of the vehicle 3000 to detect subjects 4000 in the direction the vehicle 3000 is traveling, this is not limiting. In some example embodiments, the LiDAR device 3010 may be placed at multiple locations on the vehicle 3000 to detect subjects 4000 around the entire vehicle 3000. For example, four LiDAR devices 3010 may be placed at the front, rear, and both sides of the vehicle 3000, respectively. In some example embodiments, the LiDAR device 3010 may be placed on the roof of the vehicle 3000 and rotate to detect subjects 4000 around the entire vehicle 3000.

The above description of some example embodiments of the inventive concepts provides examples for explanation of the technical idea of the present disclosure. Therefore, the inventive concepts are not limited to the above embodiments. Within the technical idea of the present disclosure, various modifications and changes are possible, such as combining and implementing the above some embodiments by those skilled in the art.

What is claimed is:

1. A single photon detection device comprising:
a first silicide layer;
a first well provided on the first silicide layer and having a first conductivity type;
a high-concentration doping region provided between the first silicide layer and the first well, having a second conductivity type different from the first conductivity type, and contacting the first silicide layer;
a contact region spaced apart from the high-concentration doping region along a direction parallel to a bottom surface of the high-concentration doping region and having the first conductivity type; and
a depletion region formed in a region adjacent to a top surface of the high-concentration doping region.

2. The single photon detection device of claim 1, further comprising:
a second silicide layer covering a bottom surface of the contact region.

3. The single photon detection device of claim 2, wherein the first well extends to a region between the high-concentration doping region and the contact region, and
wherein the first well is exposed between the first silicide layer and the second silicide layer.

4. The single photon detection device of claim 2, further comprising:
a relaxation region covering one side surface and a top surface of the contact region, having the first conductivity type, and having a lower doping concentration than that of the contact region.

5. The single photon detection device of claim 2, further comprising:
a first vertical connection provided on an opposite side of the contact region with respect to the second silicide layer,
wherein the second silicide layer electrically connects the contact region and the first vertical connection.

6. The single photon detection device of claim 2, wherein the second silicide layer has a ring shape surrounding the first silicide layer.

7. The single photon detection device of claim 1, further comprising:
a guard ring provided between the high-concentration doping region and the contact region,
wherein the first silicide layer extends to a bottom surface of the guard ring.

8. The single photon detection device of claim 7, further comprising:
an insulation pattern inserted to a lower region of the guard ring.

9. The single photon detection device of claim 7, further comprising:
a low-concentration doping region covering a side surface and the top surface of the high-concentration doping region,
wherein the first silicide layer covers a bottom surface of the low-concentration doping region.

10. The single photon detection device of claim 7, further comprising:
an additional guard ring provided on a top surface of the guard ring, having the same conductivity type as the guard ring, and having a doping concentration different from the guard ring.

11. The single photon detection device of claim 1, further comprising:
a second vertical connection provided on an opposite side of the high-concentration doping region with respect to the first silicide layer,
wherein the first silicide layer electrically connects the high-concentration doping region and the second vertical connection.

12. The single photon detection device of claim 11, further comprising:
a second silicide layer covering a bottom surface of the contact region;
a first vertical connection provided on an opposite side of the contact region with respect to the second silicide layer;
an output pattern electrically connected to an end of the second vertical connection; and
a bias pattern electrically connected to an end of the first vertical connection and spaced apart from the output pattern.

13. The single photon detection device of claim 12, further comprising:
a shield pattern located between the output pattern and the bias pattern, and spaced apart from the output pattern and the bias pattern.

14. The single photon detection device of claim 12, further comprising:
circuits of a control layer electrically connected to the output pattern and the bias pattern,
wherein the control layer is provided in the form of a separate chip.

15. The single photon detection device of claim 1, further comprising:
a second well provided between the high-concentration doping region and the first well and having the first conductivity type.

16. The single photon detection device of claim 1, further comprising:
a third well provided between the high-concentration doping region and the first well, having the second conductivity type, and having a lower doping concentration than that of the high-concentration doping region.

17. The single photon detection device of claim 1, a height of a Schottky barrier between the first silicide layer and the high-concentration doping region is smaller than a bandgap energy of the first well.

18. An electronic device configured to measure the distance to a subject using time difference information between a transmission signal of a light emission device and a detection signal of a single photon detection device, the electronic device comprising the light emission device and the single photon detection device for detecting incident light reflected from the subject after being emitted from the light emission device,
wherein the single photon detection device comprises:
a first silicide layer, a first well provided on the first silicide layer and having a first conductivity type, a high-concentration doping region provided between the first silicide layer and the first well, having a second conductivity type different from the first conductivity type, and contacting the first silicide layer, a contact region spaced apart from the high-concentration doping region along a direction parallel to a bottom surface of the high-concentration doping region and having the first conductivity type, and a depletion region formed in a region adjacent to a top surface of the high-concentration doping region.

19. The electronic device of claim 18, further comprising:
a second silicide layer covering a bottom surface of the contact region.

20. The electronic device of claim 18, further comprising:
a guard ring provided between the high-concentration doping region and the contact region,
wherein the first silicide layer extends to a bottom surface of the guard ring.
